(19) United States
(12) Patent Application Publication
(10) Pub. No.: US 2022/0282149 A1
(43) Pub. Date: Sep. 8, 2022

(54) METHODS AND COMPOSITIONS OF DISPERSIBLE FERROELECTRIC NANOPARTICLES, AND USES THEREOF

(71) Applicant: UTI Limited Partnership, Calgary (CA)

(72) Inventors: Simon TRUDEL, Calgary (CA); Maryam TAHERI, Calgary (CA); Steven BRYANT, Calgary (CA)

(21) Appl. No.: 17/683,880

(22) Filed: Mar. 1, 2022

Related U.S. Application Data
(60) Provisional application No. 63/155,456, filed on Mar. 2, 2021.

(51) Int. Cl. C09K 8/88; C01G 23/00; C09K 8/84; E21B 43/26; E21B 47/11; E21B 49/08

(52) U.S. Cl. CPC C09K 8/885; C01G 23/006; C09K 8/845; E21B 43/26; E21B 47/11; E21B 49/087; C01P 2006/42; C01P 2004/64; C01P 2004/30; C01P 2002/72; C01P 2004/03; C01P 2002/82; B82Y 40/00

(57) ABSTRACT

Methods of forming dispersible ferroelectric nanoparticles, including polyether-ylated barium titanate nanoparticles. Uses of the dispersible ferroelectric nanoparticles, including as a ferroelectric tracer material, optionally for detecting a presence and/or measuring a distribution of an oil or a hydrocarbon in a subsurface formation and/or flowback fluid. Compositions and methods involving an oil or hydrocarbon recovery fluid and the dispersible ferroelectric nanoparticles for detecting a presence, measuring a distribution, or both of an oil or a hydrocarbon in a subsurface formation and/or flowback fluid.

### CROSS REFERENCE TO RELATED APPLICATION

This application claims priority to U.S. Provisional Patent Application No. U.S. 63/155,456, filed Mar. 2, 2021, the entire contents of which are hereby incorporated by reference

### FIELD

The present disclosure relates generally to methods and compositions of dispersible ferroelectric nanoparticles, and uses thereof.

### BACKGROUND

Perovskite-type barium titanate (BaTiO₃) with four temperature-dependent crystalline forms (i.e. cubic, tetragonal, orthorhombic, and rhombohedral) is a widely used ferroelectric material that is of interest due to its applications in the electrical and electronic industries, mainly multilayer ceramic capacitors, piezoelectric sensors and dielectrics.¹ The tetragonal BaTiO₃ phase with a permanent electric polarization has a high dielectric constant between 0 to 130° C. (ferroelectric Curie temperature), while it converts to a paraelectric fully symmetric cubic structure above 130° C. In this symmetric phase, BaTiO₃ shows a temporary polarization under an application of electric field. It is known that tetragonal phase of BaTiO₃ switches to a cubic non-ferroelectric phase at room temperature below a critical size, with some early researches reporting≈100 nm,² while some recently suggested as small as a few nm.^{3,4} Recently, attention has been received on the dispersion of ferroelectric BaTiO₃ nanopowders in either aqueous or organic media.⁵⁻⁸ Since these ceramic particles are strong ferroelectric/piezoelectric/pyroelectric, cheap, non-toxic and biocompatible, they can be employed in the electrorheological fluids,⁹ biomedical applications⁸ and energy industry. Several synthesis methods for the preparation of BaTiO₃ nanosized particles have been proposed, including high temperature solid-state reaction,¹⁰ sol-gel,¹¹ co-precipitation,¹² and hydrothermal¹³ techniques. However, most of these methods are not conducive to making uniform well-dispersed BaTiO₃ nanoparticles with least defect and agglomeration, which is favorable in the ceramic industries.

### SUMMARY

In an aspect of the present disclosure, there is provided a method of forming dispersible ferroelectric nanoparticles, the method comprising adding a barium precursor and a titanium precursor to a polyether to form a mixture; basifying the mixture; heating the mixture; and forming dispersible ferroelectric nanoparticles, the dispersible ferroelectric nanoparticles comprising polyether-ylated barium titanate nanoparticles.

In an embodiment of the present disclosure, there is provided a method wherein the barium precursor comprises a barium acetylacetonate (acac) complex. In one or more embodiments, the barium acetylacetonate (acac) complex is Ba(acac)₂.xH₂O.

In another embodiment of the present disclosure, there is provided a method wherein the titanium precursor comprises a titanium acetylacetonate (acac) complex. In one or more embodiments, the titanium acetylacetonate (acac) complex is (O-i-Pr)₂Ti(acac)₂.

In another embodiment of the present disclosure, there is provided a method wherein the polyether is a low-molecular weight polyethylene glycol (PEG). In one or more embodiments, the low-molecular weight PEG is PEG₇₀₀, or PEG₆₀₀, or PEG₅₀₀, or PEG₄₀₀, or PEG₃₀₀, or PEG₂₀₀. In one or more embodiments, the low-molecular weight PEG is or PEG₄₀₀.

In another embodiment of the present disclosure, there is provided a method wherein basifying the mixture comprises adding a base and adjusting the pH of the mixture to >9, >13, or about 14. In one or more embodiments, basifying the mixture comprises adding a base and adjusting the pH of the mixture to about 9 to about 13, or to about 13 to about 14.

In another embodiment of the present disclosure, there is provided a method wherein the base is an alkali metal hydroxide. In one or more embodiments, the base is potassium hydroxide.

In another embodiment of the present disclosure, there is provided a method wherein heating the mixture comprises refluxing the mixture. In one or more embodiments, refluxing the mixture comprises refluxing at about 100° C. for between about 2 hours to about 4 hours.

In another embodiment of the present disclosure, there is provided a method wherein forming dispersible ferroelectric nanoparticles comprises forming polyether-ylated barium titanate nanoparticles by controlling particle size and dispersibility. In one or more embodiments, controlling particle size and dispersibility comprises changing Ba:Ti ratio, PEG:KOH ratio, and/or KOH molarity (e.g., for changing the particle size) as delineated in Table I below, and maintaining other reaction parameters as described herein constant. In one or more embodiments, controlling particle size comprises forming particles in a size range of about 5 to about 200 nm, or about 50 nm. In one or more embodiments, forming dispersible ferroelectric nanoparticles comprises forming polyether-ylated barium titanate nanoparticles having an average size between about 35 nm to about 70 nm; or between about 40 nm to about 65 nm. In one or more embodiments, forming dispersible ferroelectric nanoparticles comprises forming polyether-ylated barium titanate nanoparticles having a zeta potential between about −32 mV to about −22 mV; or between about −31 mV to about −28 mV; or about −30 mV. In one or more embodiments, forming dispersible ferroelectric nanoparticles comprises forming polyether-ylated barium titanate nanoparticles having a hydrodynamic radius size between about 150 nm to about 250 nm. In one or more embodiments, forming dispersible ferroelectric nanoparticles comprises forming tetragonal polyether-ylated barium titanate nanoparticles.

In another aspect of the present disclosure, there is provided a use of the dispersible ferroelectric nanoparticles formed by the method described herein as a ferroelectric tracer material.

In another embodiment of the present disclosure, there is provided a use wherein the ferroelectric tracer material is for detecting a presence and/or measuring a distribution of an oil or a hydrocarbon in a subsurface formation. In one or more embodiments, the ferroelectric tracer material is for detecting a presence and/or monitoring flow within hydrocarbon well or hydrocarbon reservoir

In another aspect of the present disclosure, there is provided a composition comprising: an oil or hydrocarbon recovery fluid, and the dispersible ferroelectric nanoparticles formed by the method described herein, the ferroelectric nanoparticles being dispersed in the recovery fluid; the composition being operable for detecting a presence, measuring a distribution, or both of an oil or a hydrocarbon in a subsurface formation.

In another aspect of the present disclosure, there is provided a composition comprising: a fracking fluid and the dispersible ferroelectric nanoparticles formed by the method described herein, the ferroelectric nanoparticles being dispersed in the fracking fluid; the composition being operable for detecting a presence and/or monitoring flowback of a flowback fluid comprising the fracking fluid and the ferroelectric nanoparticles dispersed in the fracking fluid from a hydrocarbon well or hydrocarbon reservoir.

In another aspect of the present disclosure, there is provided a method for detecting an oil or hydrocarbon in a subsurface formation, the method comprising: incorporating the dispersible ferroelectric nanoparticles formed by the method described herein into an oil or hydrocarbon recovery fluid to form a mixture; injecting the mixture into the subsurface formation; measuring a dielectric constant of the ferroelectric nanoparticles; and detecting a presence, measuring a distribution, or both of the oil or hydrocarbon in the subsurface formation.

In another aspect of the present disclosure, there is provided a method for detecting a productive portion of a hydrocarbon reservoir or hydrocarbon well with flowback fluid, the method comprising: incorporating the dispersible ferroelectric nanoparticles formed by the method described herein into a fracking fluid to form a mixture; injecting the mixture into the subsurface formation; measuring a dielectric constant of the ferroelectric nanoparticles; and detecting a presence and/or monitoring flowback of a flowback fluid, the flowback fluid comprising at least a portion of the mixture.

In another embodiment of the present disclosure, there is provided a composition or method as described herein, wherein measuring a distribution comprises measuring an oil or hydrocarbon saturation distribution.

In another aspect of the present disclosure, there is provided a method of detecting oil or a hydrocarbon, the method comprising introducing a ferroelectric tracer material into the oil or hydrocarbon, the ferroelectric tracer material comprising the dispersible ferroelectric nanoparticles formed by the method described herein; and detecting the oil or hydrocarbon. In one or more embodiments, detecting the oil or hydrocarbon comprises: detecting a presence and/or measuring a distribution of an oil or a hydrocarbon in a subsurface formation via detecting the ferroelectric tracer material; or detecting a presence and/or monitoring flow within hydrocarbon well or hydrocarbon reservoir via detecting the ferroelectric tracer material.

### BRIEF DESCRIPTION OF THE FIGURES

Embodiments of the present disclosure will now be described, by way of example only, with reference to the attached Figures.

FIG. 1 depicts refined room temperature XRD pattern of BT-1 powder. Scatter points are measured data and are superimposed with the fit; the residual is plotted below. Position of the Bragg reflections indicated by small vertical bars.

FIG. 2 depicts SEM micrographs of PEGylated-BaTiO₃ nanopowders at room temperature for samples (a) BT-1, (b) BT-2 and (c) BT-3, (d) BT-4, (e) BT-5 and (f) corresponding histograms.

FIG. 3 depicts thermal stability of BT-1 and BT-0 (BaTiO3 particles without PEG coating) using TG.

FIG. 4 depicts FT-IR transmittance spectra of PEG400, BT-1 (BaTiO₃-PEG nanoparticles), BT-4, BT-5, and BT-0 sample (BaTiO₃ particles with no PEG coating).

FIG. 5 depicts stability test of 100 ppm nanoparticles in distilled water (pH≈7) at room temperature: (a) Fresh solutions, (b) after 24 hrs, (c) ζ-Potential (solid square) and hydrodynamic particle size (circle) of all BaTiO₃ samples, and (d) time variation of ζ-Potentials of BT-1 nanoparticles in water.

FIG. 6 depicts preparation and analysis schematic diagram of BaTiO₃-PEG core-shell particles. Barium acetylacetonate hydrate (Ba(acac)₂) and titanium diisopropoxide bisacetylacetonate (Ti(acac)₂OiPr₂) were used as the Ba and Ti precursors.

FIG. 7 depicts room-temperature XRD pattern of BaTiO₃-PEG powder before washing with diluted acetic acid. Circles correspond to the Bragg peaks of carbonate impurity in the obtained product. These impurities were removed after washing the powders with diluted acetic acid (0.5 wt %).

FIG. 8 depicts powder diffractograms of pure-phase BT-1 at peak (1 1 0), fitted with Lorentzian profiles.

FIG. 9 depicts molecular structures of surfactants: anionic SDBS, cationic CTAB, and non-ionic SPAN80.

FIG. 10 depicts visual observations of water-based nanofluid stability for BP NPs at different surfactant concentrations of: a and b, no surfactant at 0 and 24 hrs respectively; c and d, SDBS surfactant at 0 and 24 hrs respectively; e and f, CTAB surfactant at 0 and 24 hrs respectively; and g and h, SPAN80 surfactant at 0 and 24 hours respectively. Concentration of surfactants were varied from 10 to 100 ppm.

FIG. 11 depicts visual observations of EG-based nanofluid stability for BP NPs at different surfactant concentrations of: a and b, no surfactant at 0 and 24 hrs respectively; c and d, SDBS surfactant at 0 and 24 hrs respectively; e and f, CTAB surfactant at 0 and 24 hrs respectively; and g and h, SPAN80 surfactant at 0 and 24 hours respectively. Concentration of surfactants were varied from 10 to 100 ppm.

FIG. 12 graphically depicts hydrodynamic diameter and ζ-potential of BP NPs in DI water vs. surfactant concentration over 24 hrs.

FIG. 13 graphically depicts hydrodynamic diameter and ζ-potential of BP NPs in EG vs. surfactant concentration over 24 hrs.

FIG. 14 depicts (a and b) UV-visible spectra of BP-DI-CTAB-80 and BP-EG-CTAB-80 nanofluids over 24 hrs, respectively; and (c and d) Surfactant concentration dependence of relative intensity (A₂₄/A₀) for BP NPs dispersed in DI and EG, respectively.

FIG. 15 depicts SEM micrographs of BaTiO₃ NPs that were dispersed in water in left column: a) BP-DI; b) BP-DI-SDBS-100; c) BP-DI-CTAB-100; d) BP-DI-SPAN80-100; and samples that were dispersed in ethylene glycol in the right column: e) BP-EG; f) BP-EG-SDBS-100; g) BP-EG-CTAB-100; h) BP-EG-SPAN80-100. All scale bars are 500 nm.

FIG. 16 depicts room temperature SEM micrographs of a) DI-SDBS; b) DI-CTAB; c) DI-SPAN80; d) EG-SDBS; e) EG-CTAB; f) EG-SPAN80. All concentrations of 100 ppm.

### DETAILED DESCRIPTION

Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, the term “low molecular weight polymer” refers to a polymer having a molecular weight (M_{w})≤700; for example, wherein M_{w}≤700, or M_{w}≤600, or M_{w}≤500 or M_{w}≤400, or M_{w}≤300, or M_{w}≤200.

As used herein, the term “productive portion” of a hydrocarbon reservoir or hydrocarbon well refers to the portion of a reservoir or well that contributes to the total flow of material out of the reservoir or well.

Generally, the present disclosure provides methods and compositions involving dispersible ferroelectric nanoparticles, and uses thereof.

Dispersible Ferroelectric Nanoparticles and Methods Thereof

Dispersion of ferroelectric nanoparticles in aqueous or non-aqueous media may be useful in electro-optical industry, medicine and smart fluid technologies. Described herein is the development of high dispersed nano-sized ferroelectric BaTiO₃ powders using a one-step low temperature chemical method. Surfaces of these tetragonal particles were modified with polyethylene glycol as a stabilizer and dispersant. Crystal structure and morphology of powders is described below. Colloidal stability and surface behavior of PEGylated barium titanate nanoparticles have been studied by means of Fourier-transform infrared spectroscopy, zeta potential and thermogravimetry-differential scanning calorimetry analysis. The work described below and herein promotes a pathway to develop advanced ferroelectric composites with engineered properties in a simple way.

BaTiO₃ particles are not thermodynamically stable in water/organic solvents, specifically in acidic aqueous solutions where Ba²⁺ ions are leached out from the surface of BaTiO₃ molecules; therefore, some modifications such as adding surfactants, polymers or polyelectrolytes are generally needed.¹⁴ Poly(ethylene glycol) (PEG) was chosen and used herein to stabilize dispersed nano-sized BaTiO₃ particles because it is soluble in both polar and non-polar solvents, biocompatible, eco-friendly, simple and well-studied nanoparticles' stabilizing ligand.¹⁵ Although PEG has been broadly used in the synthesis of nanoparticles as a stabilizer and grain particle's controller, little research has been reported about using this polymer as a dispersant for BaTiO₃ nanoparticles.^{16,17} Moreover, it has been reported that PEG as a modifying agent can improve the dielectric properties of ceramic particles which is an important factor in ferroelectric applications.^{16,18}

Herein described is the preparation and characterization of surface modified nano-sized BaTiO₃ powders using a low temperature chemical synthesis technique. This method is fast, simple and cost-effective which can be of interest for industrial nanoparticles preparation purposes. Li, et.al.¹⁹ claimed the preparation of BaTiO₃-polyvinylpyrrolidone composite using TiCl₄ and BaCl₂ as starting materials through low temperature chemical synthesis method which ended in formation of cubic particles with an average particle size of 160 nm. Herein is reported the synthesis of tetragonal BaTiO₃-PEG core-shell nanoparticles with smaller particle size and high water dispersibility. Since the solubility and miscibility of PEG decreases with increasing molecular weight, low molecular weights of this polymer (Mw=400) was used. Zeta potential measurements over temperature, Fourier-transform infrared spectroscopy, and thermogravimetry-differential scanning calorimetry studies were carried out to better understand the surface behavior of PEGylated BaTiO₃ powders.

In one or more embodiments of the present disclosure, there is provided a method of forming dispersible ferroelectric nanoparticles, the method comprising adding a barium precursor and a titanium precursor to a polyether to form a mixture; basifying the mixture; heating the mixture; and forming dispersible ferroelectric nanoparticles, the dispersible ferroelectric nanoparticles comprising polyether-ylated barium titanate nanoparticles.

In one or more embodiments of the present disclosure, there is provided a method wherein the barium precursor comprises a barium acetylacetonate (acac) complex. In one or more embodiments, the barium acetylacetonate (acac) complex is Ba(acac)₂.xH₂O.

In one or more embodiments of the present disclosure, there is provided a method wherein the titanium precursor comprises a titanium acetylacetonate (acac) complex. In one or more embodiments, the titanium acetylacetonate (acac) complex is (O-i-Pr)₂Ti(acac)₂.

In one or more embodiments of the present disclosure, there is provided a method wherein the polyether is a low-molecular weight polyethylene glycol (PEG). In one or more embodiments, the low-molecular weight PEG is PEG₇₀₀, or PEG₆₀₀, or PEG₅₀₀, or PEG₄₀₀, or PEG₃₀₀, or PEG₂₀₀. In one or more embodiments, the low-molecular weight PEG is or PEG₄₀₀.

In one or more embodiments of the present disclosure, there is provided a method wherein basifying the mixture comprises adding a base and adjusting the pH of the mixture to >9, >13, or about 14. In one or more embodiments, basifying the mixture comprises adding a base and adjusting the pH of the mixture to about 9 to about 13, or to about 13 to about 14.

In one or more embodiments of the present disclosure, there is provided a method wherein the base is an alkali metal hydroxide. In one or more embodiments, the base is potassium hydroxide.

In one or more embodiments of the present disclosure, there is provided a method wherein heating the mixture comprises refluxing the mixture. In one or more embodiments, refluxing the mixture comprises refluxing at about 100° C. for between about 2 hours to about 4 hours.

In one or more embodiments of the present disclosure, there is provided a method wherein forming dispersible ferroelectric nanoparticles comprises forming polyether-ylated barium titanate nanoparticles by controlling particle size and dispersibility. In one or more embodiments, controlling particle size and dispersibility comprises changing Ba:Ti ratio, PEG:KOH ratio, and/or KOH molarity (e.g., for changing the particle size) as delineated in Table I below, and maintaining other reaction parameters as described herein constant. In one or more embodiments, forming dispersible ferroelectric nanoparticles comprises forming polyether-ylated barium titanate nanoparticles having an average size between about 35 nm to about 70 nm; or between about 40 nm to about 65 nm. In one or more embodiments, forming dispersible ferroelectric nanoparticles comprises forming polyether-ylated barium titanate nanoparticles having a zeta potential between about −32 mV to about −22 mV; or between about −31 mV to about −28 mV; or about −30 mV. In one or more embodiments, forming dispersible ferroelectric nanoparticles comprises forming polyether-ylated barium titanate nanoparticles having a hydrodynamic radius size between about 150 nm to about 250 nm. In one or more embodiments, forming dispersible ferroelectric nanoparticles comprises forming tetragonal polyether-ylated barium titanate nanoparticles.

In any one or more embodiments, the polyether acts as a solvent for mixing the barium precursor and titanium precursor. In any one or more embodiments, the polyether comprises, consist essentially of, or consist of a low-molecular weight polyethylene glycol (PEG). In some embodiments, the PEG has a molecular weight (M_{w}) of ≤700, as PEGs having higher molecular weights are solids or semi-solids. In any one or more embodiments, the PEG has a M_{w} of about 400. In some embodiments, the PEG has a M_{w}≤700, or M_{w}≤600, or M_{w}≤500 or M_{w}≤400, or M_{w}≤300, or M_{w}≤200. In some embodiments, using a PEG having a M_{w} of about 700 may form smaller nanoparticles relative to using a PEG having a M_{w} between about 400 to <700. In some embodiments, using a PEG having a M_{w} that is <400 may require using a greater amount of PEG for nanoparticle formation, relative to using a PEG having a M_{w}>400.

In any one or more embodiments, the barium precursor comprises, consists essentially of, or consists of a barium acetylacetonate (acac) complex. In any one or more embodiments, the titanium precursor comprises, consists essentially of, or consists of a titanium acetylacetonate (acac) complex. In any one or more embodiments, the barium precursor is Ba(acac)₂.xH₂O and the titanium precursor is is (O-i-Pr)₂Ti(acac)₂. In any one or more embodiments, using a barium acetylacetonate (acac) complex such as Ba(acac)₂.xH₂O, and using a titanium acetylacetonate (acac) complex such as (O-i-Pr)₂Ti(acac)₂ in the formation of barium titanate nanoparticles allows, at least in part, the surface-modification of those barium titanate nanoparticles with the polyether such as PEG. In any one or more embodiments, the barium precursor does not comprise, does not consist essentially of, or does not consist of barium hydroxide, and the titanium precursor does not comprise, does not consist essentially of, or does not consist of titanium oxide, as such precursors do not permit for surface-modification of barium titanate nanoparticles with a polymer such as the polyether (e.g., PEG).

In any one or more embodiments of the method described herein, using acidic conditions can leach Ba²⁺ ions out of the nanoparticle formation, such that the main phase formed is TiO₂. As such, the method as described herein comprises basifying for forming the dispersible ferroelectric nanoparticles. In any one or more embodiments, basifying the mixture of the barium precursor, titanium precursor, and polyether comprises adding a base and adjusting the pH of the mixture to >9, >13, or about 14. In any one or more embodiments, basifying the mixture comprises adding a base and adjusting the pH of the mixture to about 9 to about 13, or to about 13 to about 14. In any one or more embodiments, basifying the mixture to a low alkaline pH, between about 9 to about 13, may require higher amounts of barium precursor to precipitate BaTiO₃ nanoparticles without a high level of impurity—relative to basifying the mixture to a higher pH of >13, which precipitates the BaTiO₃ nanoparticles with a lower level of impurity.

Dispersible Ferroelectric Nanoparticles and Stability Thereof

Perovskite biocompatible BaTiO₃ nanoparticles (NPs) with ferroelectric, piezoelectric and pyroelectric properties have attracted interest for a wide range of applications in electronic-optical ceramics, such as multilayer capacitors, sensors, and microwave dielectric ceramics or biomedical applications including implant technology,^{30,31} drug delivery,³² cancer therapy³³, and computed tomography contrast agents.³⁴ Magnetic or ferroelectric nanoparticles are more common candidates for nanofluids e.g. colloidal dispersions of nanomaterials in liquids) since they are easily detectable due to their orthogonal properties not typically encountered in their surrounding medium. A factor to successful manufacturing of miniaturized electronic ceramic films in wet fabrication techniques, such as colloidal processing or tape casting, include the achievement of well-dispersed particles in the suspending medium.₃₅₋₃₇ Furthermore, the efficiency of NPs in biomedical applications was found to depend on their stability in suspension. Nanofluid stability can be tuned by variations in the solution, such as pH, temperature, salinity, surfactant, or change to the structure of NPs including surface modification, particle size, or concentration.³⁸

Dispersing BaTiO₃ NPs in water can be challenging, since they tend to be hydrophobic and thermodynamically unstable in solutions with pH lower than 10.³⁹ Ba²⁺ ions easily leach from the surface of BaTiO₃ particles in acidic media, leading to composition change and precipitation. Therefore, it is needed to find an appropriate solution that stabilizes the BaTiO₃ NPs, forming a homogeneous dispersion. Surface coating or adding surfactants are common solutions to develop stabilized BaTiO₃ NPs in water or organic media.³⁹

Several approaches have been reported on the dispersion and stability of BaTiO₃ water-based dispersions, using various polymers or polyelectrolytes such as ammonium salt of poly(acrylic acid),⁴⁰⁻⁴² poly(vinyl alcohol) co-polymers with carboxylic acid group,⁴³ poly(aspartic acid),⁴⁴ and poly-Llysine.³² However, preventing aggregation of BaTiO₃ NPs and increasing their dispersibility can still be challenging Herein, the influence of multiple surfactants to enhance the stability of these NPs in two different solvents is investigated and described.

Surfactants (e.g., surface active agents) are organic compounds consisting of two different moieties that are hydrophilic and hydrophobic. They are classified in four groups based on the charge existing on the hydrophilic head, e.g., non-ionic (without any charge), anionic (negative charge), cationic (positive charge), and zwitterionic (both negative and positive charges).³⁸ According to Gbadamosi et al.,⁴⁶ the hydrophobic tail group of a surfactants is often made of a short polymer chain, a long hydrocarbon chain, a siloxane chain or a fluorocarbon chain, while the hydrophilic head group is made of moieties such as sulfates, sulfonates, polyoxyethylene chains, carboxylates, alcohols or quaternary ammonium salts.

Dispersions will be stable when the repulsive forces between the NPs overcome the attractive forces between the same particles. Surfactants at low concentrations can adsorb onto surfaces or interfaces and change the surface or interfacial free energy, usually reducing the interfacial free energy.⁴⁷ On the other hand, surfactants at high concentrations (e.g., above the critical micelle concentration) in water aggregate and form micelles. In this situation, the hydrophobic tails aggregate to the interior to reduce their contact with water, and the hydrophilic heads stay on the outer surface to maximize their contact with water.^{48,49} The stability of particles in a solution can depend on the balance of steric, electrostatic, hydrogen bonding, and/or Van der Waals interactions.

Steric repulsions can display a stabilizing effect with the aid of non-ionic surfactants and polymers that can be adsorbed at the phase interface.⁵⁰ The thickness of the adsorbed layer can impact the balance between attractive and repulsive forces, which for polymers depends not only on the chain length, but also on its adsorption mode.^{51,52} More commonly used polymers for steric stabilization include poly(ethylene glycol),⁵³ poly(vinylalcohols),⁵⁴ poly(vinylpyrrolidones),^{55,56} poly(acrylamides),⁵⁷ and/or poly(urethanes).⁵⁸ Non-ionic surfactants such as Brij, Tween, and Triton X-100 can adsorb in a more compact mode at NP surfaces relative to polymers, which can create a strong stabilizing effect.^{59,60} Ionic surfactants can increase surface charge of the dispersed phase. This charge can provide electrostatic repulsion between NPs, preventing them from adhering to one another. More commonly applied ionic surfactants as stabilizing agents include sodium dodecyl sulfate (SDS)⁶¹ as a an anionic surfactant, and cetyltrimethylammonium chloride or bromide,⁶² as cationic surfactants.^{62,63}

Use of surfactants to control the size and agglomeration of NPs to improve their stabilization have been investigated. Hwang et al.⁶⁴ used SDS and oleic acid to stabilize nanofluids and showed that surfactants were effective in stabilizing nanofluids by increasing the magnitude of their z-potential. Kvitek et al.⁶⁵ reported the stability of uniformly sized silver NPs adding a variety of surfactants and polymers, using dynamic light scattering, UVvisible spectroscopy and transmission electron microscopy analysis. It was found that the two surfactants of an SDS (anionic) and poly(oxyethylenesorbitane monooleate) (nonionic) surfactants along with poly(vinylpyrrolidone) polymer prevented aggregation of silver NPs by means of both steric and electrostatic stabilization. Yi et al.⁶⁶ investigated the stability of nickel NP suspensions using anionic SDS, cationic cetyltrimethylammonium bromide (CTAB), and polyoxyalkalene amine derivative (Hypermer) along with xanthan gum polymer. The static stability tests and z-potential measurements revealed the stability of nickel NPs with a combination of surfactant and polymer. Faraji et al.⁶⁷ showed a drastic increase in the colloidal stability of aluminum NPs in the presence of SDS surfactant during 48 hrs. Jiang et al.⁶⁸ studied the effect of SDS surfactant on stability of carbon nanotube (CNT) fluids and found an increase in the z-potential of the SDS-CNTs nanofluids compared to that of the bare CNTs. They suggested that the electrostatic repulsion between the negatively charged cluster surfaces stabilized the CNT nanofluids. Wang et al.⁶⁹ also observed that SDS significantly increased the absolute z-potential value in titania and alumina nanofluids by the mass fraction of 0.01 and 0.05%, respectively. Ghadimi et al.⁷⁰ investigated the stability of titania nano-suspensions by comparing the effect of SDS surfactant addition and ultrasonic processing. The most stable suspension was found using 0.1 wt % of SDS surfactant and 3 hrs ultrasonic bath process. In the case of cationic surfactants, Koglund et al.⁷¹ studied the structural behavior in aqueous mixtures of negatively charged silver NPs with the CTAB and dodecyltrimethylammonium chloride (DTAC). They proposed a mechanism for the stabilization of negatively charged Ag NPs in a solution of positively charged surfactants in which cluster formation of micelles in the vicinity of the particles prevented the particles from aggregating. Similarly, a recent small angle neutron scattering study on gold nano rods with CTAB proposed that the surfactants were present in a bilayer structure at the nanorod interface.⁷³

As described herein, the effect of different surfactants on the colloidal stability of BaTiO₃ dispersion was investigated. To probe the effect of charge, an anionic (sodium dodecylbenzenesulfonate, SDBS), a cationic (cetyltrimethylammonium bromide, CTAB), and a non-ionic (sorbitan monooleate, SPAN 80) surfactant was selected, shown in FIG. 9. A comparative analysis of the stability of water and ethylene glycol (EG)-based BaTiO₃ nanofluids was conducted by means of dynamic light scattering (DLS), z-potential, UV-visible spectroscopy, and scanning electron microscopy (SEM). Water, EG and EG/water mixture are commonly-used heat transfer fluids in many industrial sectors including power generation, chemical production, air-conditioning, transportation and microelectronics.⁷³ EG is an organic liquid with low viscosity and low volatility that can prevent ice formation in water by lowering the water freezing point (e.g., in engine coolant fluids for cold regions), or can increase the water boiling point (e.g., as used in car radiators or industrial heat exchangers).⁷⁴ Described herein is an investigation of parameters affecting the stability of BaTiO₃ NPs in aqueous and non-aqueous media, particularly, focusing on the effects of surfactant and solvent interactions.

In one or more embodiments of the present disclosure, there is provided a nanofluid comprising: the dispersible ferroelectric nanoparticles formed by any one of the methods described herein, a solvent, and a surfactant, the ferroelectric nanoparticles being stabilized and dispersed in the solvent by the surfactant. In one or more embodiments, the solvent is an aqueous solution, a protic solvent, an oil or hydrocarbon recovery fluid, a fracking fluid, a flowback fluid, or a combination thereof. In one or more embodiments, the protic solvent comprises water, a poly-ol, such as ethylene glycol, or a combination thereof. In one or more embodiments, the surfactant comprises an anionic surfactant, cationic surfactant, non-ionic surfactant, or a combination thereof. In one or more embodiments, the surfactant comprises sodium dodecylbenzenesulfonate (anionic), cetyltrimethylammonium bromide (cationic), sorbitan monooleate/polysorbate 80 (non-ionic), or a combination thereof. In one or more embodiments, the surfactant comprises an anionic surfactant, such as sodium dodecylbenzenesulfonate (SDBS). In one or more embodiments, the surfactant comprises a non-ionic surfactant, such as sorbitan monooleate/polysorbate 80 (SPAN80). In one or more embodiments, the surfactant comprises a cationic surfactant, such as cetyltrimethylammonium bromide (CTAB). In one or more embodiments, the nanofluid is operable for detecting a presence, measuring a distribution, or both of an oil or a hydrocarbon in a subsurface formation.

Dispersible Ferroelectric Nanoparticles, Compositions and Uses Thereof

When undertaking oil or hydrocarbon recovery processes at one or more oil or hydrocarbon reservoirs, such as improved oil recovery processes (IOR), being able to assess performance of the recovery process during the early stages of the operation can facilitate the overall management of the process. For example, if before and immediately after the implementation of an oil or hydrocarbon recovery process (e.g., water-flooding) the spatial distribution of oil/hydrocarbon in the reservoir could be determined, it could substantially impact optimal reservoir management.

Further, accurate and non-invasive determination of oil or hydrocarbon saturation distribution in oil/hydrocarbon reservoirs can improve understanding of oil/hydrocarbon displacement mechanisms for various oil recovery processes, such as enhanced oil recovery processes, and also help identify the location of bypassed oils/hydrocarbons so that they can be subsequently recovered. Oil/hydrocarbon saturation distributions can be determined: (i) for laboratory cores, using MRI or CT-scan imaging; (ii) for near-wellbore zones, by NMR and other logging methods; and (iii) for zones deeper in the reservoir, e.g., by injection of partitioning tracers. A difficulty with NMR logging is that its probing depth is very shallow (e.g., in centimeters); and interpretation requires knowledge of rock surface properties (wettability, relaxivity).

The dispersible ferroelectric nanoparticles as described herein may serve as a tracer material, where the nanoparticles are injected with an oil/hydrocarbon recovery injection fluid into a subsurface formation, absorb into the oil/hydrocarbon, and/or absorb at the oil or hydrocarbon/fluid interface within the subsurface formation, and are then remotely detected, thereby indicating the presence and/or distribution of oil/hydrocarbon in the formation. Additionally, the nanoparticles may serve as a tracer material where the nanoparticles are dissolved in the injection fracking fluid at the surface before it is pumped down the injection well, and are then detected after the fracking fluid flows back to observe flow paths and transit times between injection wells and production wells. The overall concentration of the nanoparticles in the oil/hydrocarbon or oil or hydrocarbon/fluid interface can be measured using equipment suitable for detecting ferroelectric materials, such as impedance analyzer or LCR meter.

As used herein, the term “ferroelectricity” refers to a property of particular materials which exhibit a spontaneous electric polarization. This electric polarization is reversible under an external electric field, yielding a polarization-electric field (P-E) hysteresis loop. In some examples, ferroelectric materials have high dielectric constant. Particularly, when ferroelectric nanoparticles are dispersed in a liquid phase, their presence can be detected by measuring polarization-electric field (P-E) hysteresis loop or their dielectric constant (ϵᵣ). Dielectric constant (ϵᵣ) or relative permittivity is defined through:

$${ε}_{r} = χ + 1 where χ = \frac{P}{{ε}_{0} E}$$

where ϵᵣ is permittivity of a vacuum and Ψ is electric susceptibility. The dielectric constant can be measured with an impedance analyzer or LCR meter at different temperature or frequency. Because ϵᵣ in general increases monotonically with the volume fraction of ferroelectric nanoparticles in the mixture, it can be employed as a convenient way of measuring particle concentration in a fluid, after developing a calibration curve that provides correlation between ϵᵣ and concentration. Because the measurement can be made even when the nanoparticle-containing fluid is not transparent, the method can be used to measure the concentration of a ferroelectric tracer material in fluids such as crude oil or other hydrocarbons. Further, the measurement can be made and converted to the concentration value without involving any chemical analysis as with many conventional tracers.

In one or more embodiments of the present disclosure, there is provided a use of the dispersible ferroelectric nanoparticles formed by the method described herein as a ferroelectric tracer material.

In one or more embodiments of the present disclosure, there is provided a use wherein the ferroelectric tracer material is for detecting a presence and/or measuring a distribution of an oil or a hydrocarbon in a subsurface formation. In one or more embodiments, the ferroelectric tracer material is for detecting a presence and/or monitoring flow within hydrocarbon well or hydrocarbon reservoir

In one or more embodiments of the present disclosure, there is provided a composition comprising: an oil or hydrocarbon recovery fluid, and the dispersible ferroelectric nanoparticles formed by the method described herein, the ferroelectric nanoparticles being dispersed in the recovery fluid; the composition being operable for detecting a presence, measuring a distribution, or both of an oil or a hydrocarbon in a subsurface formation.

In one or more embodiments of the present disclosure, there is provided a composition comprising: a fracking fluid and the dispersible ferroelectric nanoparticles formed by the method described herein, the ferroelectric nanoparticles being dispersed in the fracking fluid; the composition being operable for detecting a presence and/or monitoring flowback of a flowback fluid comprising the fracking fluid and the ferroelectric nanoparticles dispersed in the fracking fluid from a hydrocarbon well or hydrocarbon reservoir.

In one or more embodiments of the present disclosure, there is provided a method for detecting an oil or hydrocarbon in a subsurface formation, the method comprising: incorporating the dispersible ferroelectric nanoparticles formed by the method described herein into an oil or hydrocarbon recovery fluid to form a mixture; injecting the mixture into the subsurface formation; measuring a dielectric constant of the ferroelectric nanoparticles; and detecting a presence, measuring a distribution, or both of the oil or hydrocarbon in the subsurface formation.

In one or more embodiments of the present disclosure, there is provided a method for detecting a productive portion of a hydrocarbon reservoir or hydrocarbon well with flowback fluid, the method comprising: incorporating the dispersible ferroelectric nanoparticles formed by the method described herein into a fracking fluid to form a mixture; injecting the mixture into the subsurface formation; measuring a dielectric constant of the ferroelectric nanoparticles; and detecting a presence and/or monitoring flowback of a flowback fluid, the flowback fluid comprising at least a portion of the mixture. In one or more embodiments, the productive portion of the hydrocarbon reservoir or hydrocarbon well is the portion that contributes to the total flow of material from the reservoir or well. In some embodiments, it contributes a majority of the total flow of material. In one or more embodiments, the productive portion is the portion that has been stimulated with fracturing stages, e.g., multiple fracturing stages, and contributes to the total flow of material from the reservoir into the well, or the total flow of material out of the well.

In one or more embodiments of the present disclosure, there is provided a composition or method as described herein, wherein measuring a distribution comprises measuring an oil or hydrocarbon saturation distribution.

In any one or more embodiments, the dispersible ferroelectric nanoparticles formed by the method as described herein may be used in the electro-optical industry; may be used in medicine; and/or may be used in smart fluid technologies.

To gain a better understanding of the invention described herein, the following examples are set forth. It should be understood that these examples are for illustrative purposes only. Therefore, they should not limit the scope of this invention in anyway.

### EXAMPLES

### Example 1

### Low-Temperature Synthesis of Water Dispersed PEGylated Barium Titanate Nanoparticles

Materials

High-purity barium(II) acetylacetonate hydrate (Ba(acac)₂.xH₂O) and titanium diisopropoxide bis(acetylacetonate) ((O-i-Pr)₂Ti(acac)₂, 75 wt. % in isopropanol), poly(ethyleneglycol) (HO(CH₂CH₂O)ₙH); PEG₄₀₀: M_{w}=400) and potassium hydroxide (KOH, 85%) were purchased from Sigma Aldrich. Ethanol, glacial acetic acid (99.7%) and formic acid (98%) were used for nanoparticles' washing procedure. Barium titanate powders (as-BT, with 99% purity and particle size of <3 μm) purchased from VWR was employed as FTIR reference. All chemicals and solvents were used as-received without any further purification. High-purity water (resistivity of 18 MΩ·cm) was used in all experiments.

Nanoparticle Synthesis

PEGylated BaTiO₃ nanoparticles were prepared using a one step chemical synthetic protocol. All reactions were carried out under stirring and nitrogen atmosphere while temperature was monitored and controlled with a digital thermometer. In a representative synthesis, Ba(acac)₂.xH₂O and (O-i-Pr)₂Ti(acac)₂ precursors were dissolved in PEG₄₀₀ in a round-bottom flask under nitrogen atmosphere and stirred for 30 min. Aqueous KOH was added to the mixture to adjust the pH of the solution to ca. 14, which was needed for the nucleation and crystallite formation of BaTiO₃ particles.¹⁹ Immediately after, the solution was heated to reflux (ca. 100° C.) for 2 hrs. The color of solution gradually changed from orange/brown to white. At this point, distilled water (in the same volume of KOH solution as summarized in Table I) was added to the mixture and maintained at 100±5° C. for an additional 2 hrs. Then the system was opened to the air and cooled down to room temperature. White precipitates were collected, washed and centrifuged (6000 rpm for 10 min) two times with ethanol, followed by washing and centrifugation with formic acid (1M). Final carbonate impurities were removed by washing the product with diluted acetic acid solution. Finally, nanoparticles were dried in air at 60° C. in a vacuum oven for overnight. In order to study the effect of reaction conditions on particle size and dispensability of BaTiO₃-PEG nano-powders, the concentrations of the starting materials—(Ti and Ba molar ratio), KOH, and PEG—were varied for samples BT-1 to BT-5, as summarized in Table I. Sample BT-0 nano-powder was prepared with the same amounts of precursors used in the sample BT-1 but with PEG eliminated, to be employed as a BaTiO₃ reference sample with no surface modification in FT-IR and DLS analysis.

Nanoparticle Characterization

Structural characterization was carried out using a Bruker D8 ECO Advance powder diffractometer (Cu Kα, λ=1.5406 Å, 25 mA×40 kV power, in the range of 2Θ=15-79°, and increment of 0.02°). Profile refinement of XRD patterns was performed with the Full prof software.²⁰ Crystallite size (D_{XRD}) was estimated using the Scherrer equation (see Example 2).²¹ A Zeiss Σigma VP field-emission scanning electron microscope (SEM) was used to image the NPs. Powders were mounted on the SEM sample stubs using the double sided adhesive tape. Micrographs were analysed using ImageJ software.²²

Thermogravimetric analysis combined with differential scanning calorimetry (TGA-DSC) was carried out with a Netzsch STA 409 PC. Data were recorded for ≈7 mg of powders in a Al₂O₃ pan at a heating rate of 10° C. min⁻¹ from 20 to 820° C. under N₂ atmosphere (flow rate of 60 mL min⁻¹).

Fourier-transform infrared spectroscopy (FT-IR) was measured with an Agilent Cary 630 spectrum with a diamond attenuated total reflectrance (ATR) probe.

Hydrodynamic diameter and Zeta-potential (ζ) of dispersed nanoparticles in disposable cuvette were performed using a Malvern Zetasizer Nano ZS dynamic light scattering (DLS) system. For each time-point, three sequential measurements were made at room temperature to estimate the surface charge and dispersiblity of 100 ppm dried BaTiO₃-PEG nanoparticles in DI water.

### Results and Discussion

Structural Analysis

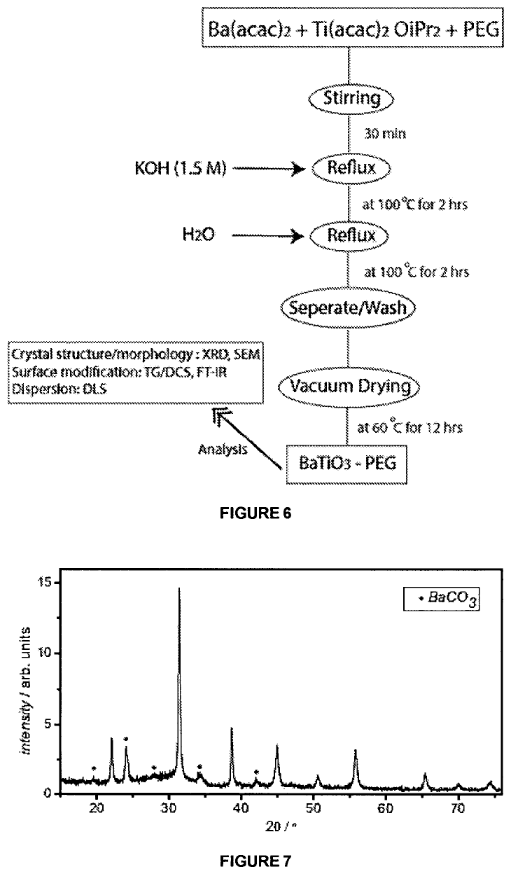

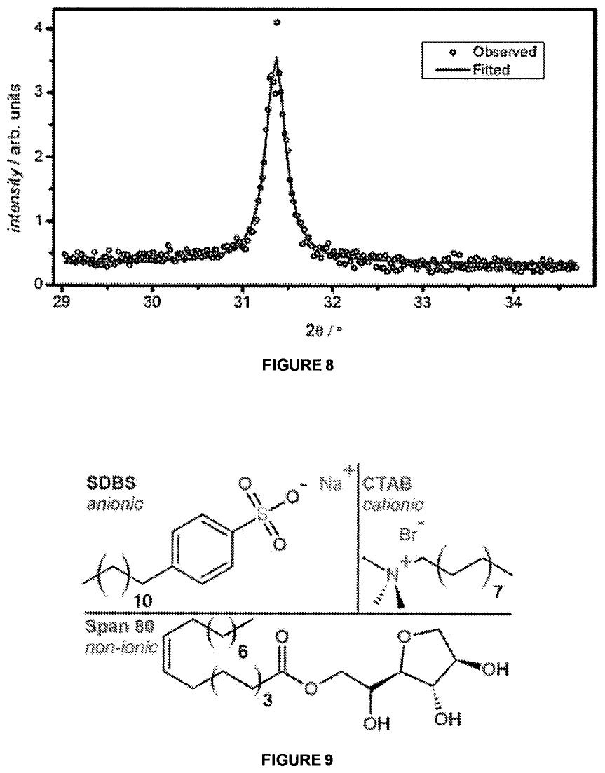

Following synthesis, the room-temperature powder X-ray diffraction pattern (PXRD) of the synthesized powder indicated the major product of the reaction was BaTiO₃. However, the presence of a minor impurity corresponding to BaCO₃ was detected (FIG. 7). This impurity was easily removed by washing the powders with diluted acetic acid (0.5% w/w), which is known to dissolve BaCO₃.²³ After washing, all PXRD patterns show a single-phase product consisting of only BaTiO₃.

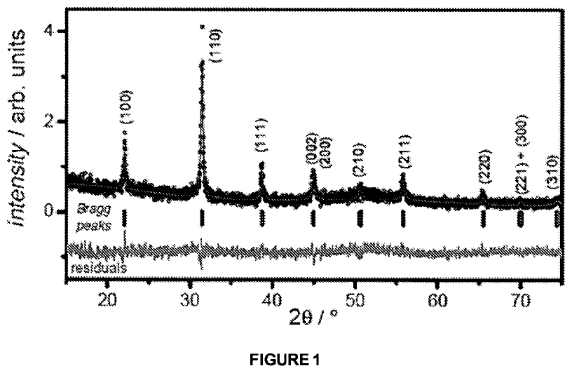

FIG. 1 represents the PXRD of sample BT-1 at room temperature including its (h k I) Miller indices of the Bragg's reflections. Slight splitting of two peaks at (002) and (200) around 2Θ≈45° suggests the formation of a tetragonal structure with the space group of P4/mmm, whereas a single (200) peak would be observed for cubic BaTiO₃ (space group: Pm3m). Rietveld XRD refinement gave lattice parameters of a=b=4.03 Å and c=4.05 Å for sample BT-1, which are slightly larger than lattice parameters' of bulk BaTiO₃ but in good agreement with published values of 4.03 to 4.05 Å in some BaTiO₃ nanoparticles.²⁴⁻²⁵ The tetragonality value of c/a=1.005 suggests the structure is moderately tetragonal, while strong tetragonality value is reported about 1.01.²⁶ Tetragonality of produced particles can be tuned by controlling the synthesis conditions, including Ba/Ti ratio, temperature and duration of synthesis or pH of solution. Herein, lattice parameters of samples with smaller particle sizes slightly increased, indicating a smaller tetragonality value. Smaller nanoparticles can have a larger unit cell, owing to various factors including defects, surface tension or symmetry reduction. Lattice expansion of BaTiO₃ nanoparticles by size reduction has been reported, which lead to converting the tetragonal phase to the cubic phase structure in very small particles.^{27-28.} Table II summarizes the calculated lattice parameters from refinement XRD patterns.

The crystallite size of particles were calculated from Scherrer's equation²¹ through fitting of the (110) peak, (see FIG. 8 and equations in the Example 2). The value of 40±1 nm was obtained for BT-1 powders which decreased through increasing concentration of Ba⁺², polymer PEG content and KOH molarity (See Table I).

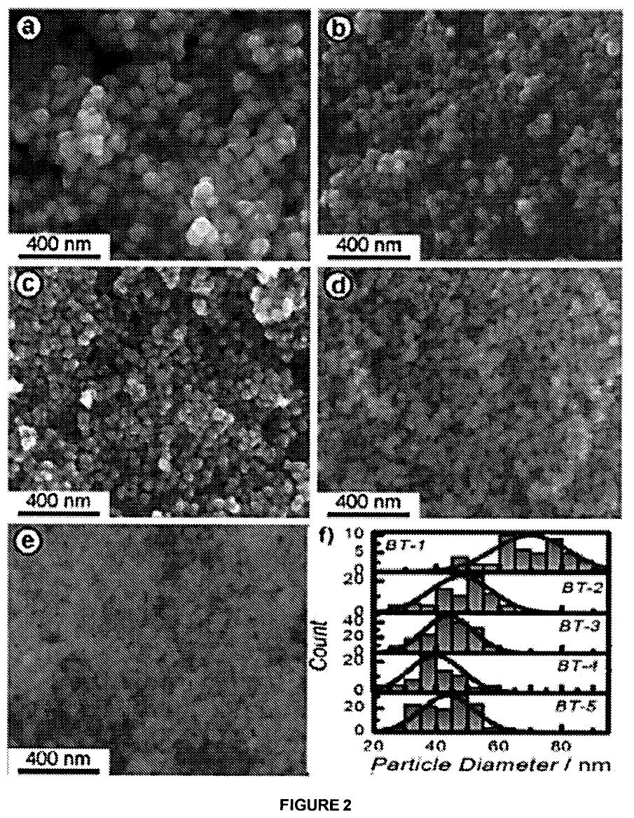

The morphology of PEGylated BaTiO₃ nanoparticles were analyzed by SEM (FIG. 2). As can be seen in the micrographs, particles surrounded with polymer structures were almost uniform spherical with rough surfaces due to the PEG adsorbed on the surface of BaTiO₃ particles. An average particle size was shrinking from ≈70 nm in the sample BT-1 to ≈40-48 nm in sample BT-2 to BT-5, with no change in the shape of particles. All average particle sizes were shown in Table I.

Thermogravimetric Analysis

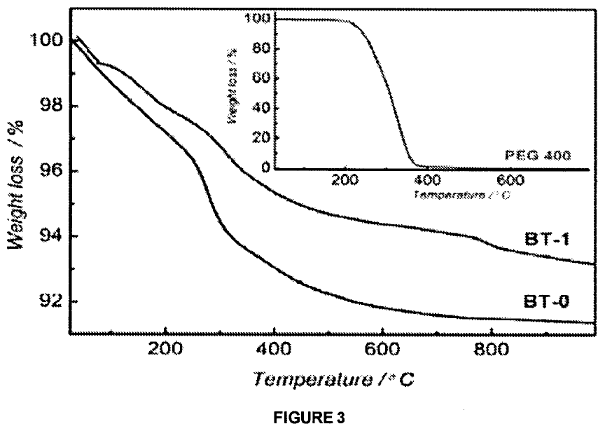

Thermal stability of the BT-1 and BT-0 (BaTiO₃ particles without PEG coating) using TG are shown in FIG. 3. About 3-5% weight loss occurred below in both BaTiO₃ samples below an exothermic peak of T≈200° C. due to the desorption of physisorbed water molecules on the surface of particles. The larger weight loss in BT-0 sample can be of attributed to existence of organic components on the surface due to the synthesis method. The weight loss temperature dependence of PEG 400 polymer represented in the inset shows that its thermal decomposition started around 250° C. and ended at around 400° C. Detecting broad peak around 315° C. in derivative weight loss of BT-1 is overlapping of the sharp peak of BT-0 thermal decomposition (≈280° C.) and the sharp peak of PEG 400 thermal decomposition (≈325° C.), which indicating the presence of the capped PEG molecules in BT-1 nanoparticles.

FT-IR Spectrum

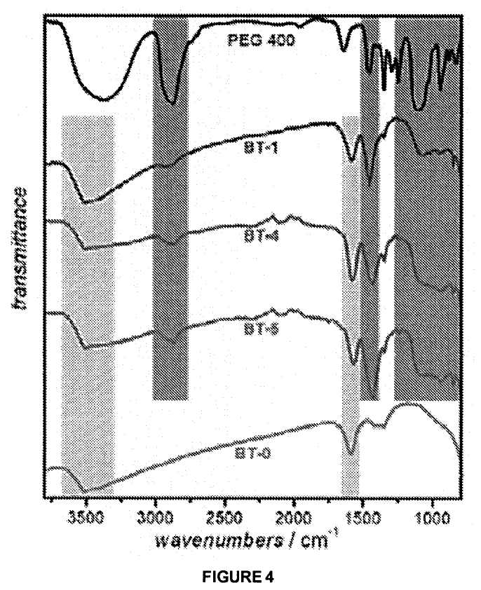

The interaction between polymer and the nanoparticles' surface was analyzed by FT-IR measurement. FIG. 4 represents the FT-IR spectra of PEGylated-BaTiO₃ nanoparticles and PEG₄₀₀. Data were compared with an FT-IR spectrum of BaTiO₃ particles prepared with the same synthesis method (BT-1) and no surface modification (BT-0). There were several common bands in both PEG₄₀₀ and PEGylated nanoparticles spectra which were absent in the spectrum of sample with no PEG added.

The peak near 950 cm⁻¹ was characterized by the C-H out-of-plane bending vibrations; features between 990 to 1250 cm⁻¹ corresponded to the in plane C—H and O—H as well as C—O—C stretching vibrations; peak around 1450 cm⁻¹ was associated with the C—H bending vibration, the band around 2900 cm⁻¹ was assigned to —CH2 stretching vibrations. The O—H stretching modes of surface adsorbed water was shown around 3500 cm⁻¹ in all BaTiO₃ samples.

Zeta Potential

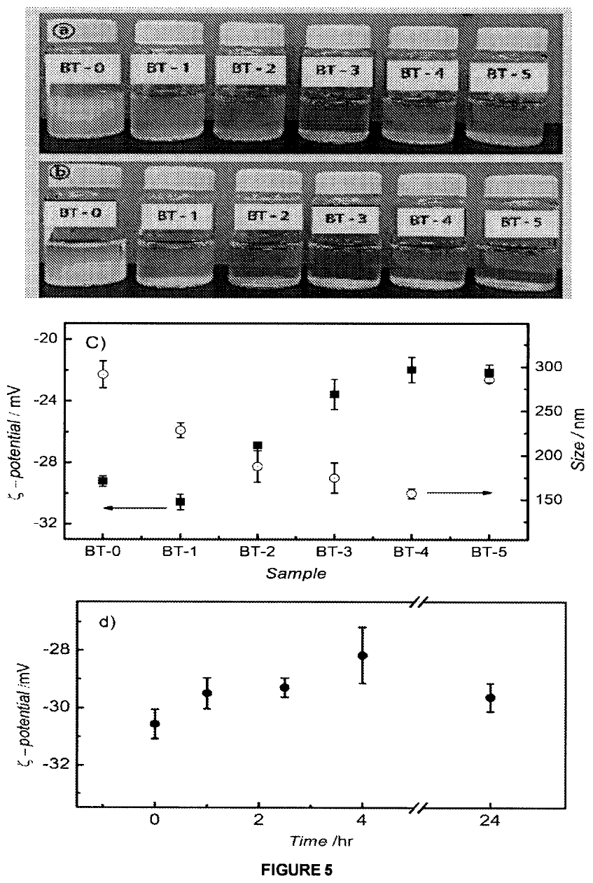

FIG. 5a illustrates the images of 100 ppm BaTiO₃ nanoparticles in deionized water (pH≈7) after 10 min sonication with ultra-sonic homogenizer (≈4 kJ energy) while FIG. 5b shows the solutions after 24 hrs with no disturbing. Stability of nanoparticles were examined by measuring their ζ-Potential and hydrodynamic sizes using DLS measurement (FIGS. 5c and d). The visual test showed that the color of BT-0 solution was more whitish-milky where phase separation and particles precipitation were clear after 24 hrs (FIG. 5b). Without being bound by theory, the large hydrodynamic particle size (≈300 nm) may be the reason of low stability of these particles in the solution. Furthermore, although particle sizes of BT-2, BT-3 and BT-4 were smaller, they had lower ζ-Potential. Sample BT-1 showed highest ζ-Potential among all samples. Zeta potential (ζ) of 100 ppm BT-1 nanoparticles in deionized (DI) water (pH≈7) over 24 hrs were measured in order to better understand the nanoparticles' stability (see FIG. 5d). The obtained values showed an slight change over a period of 24 hrs with an average absolute zeta potential of 29.6±0.5 mV, which is an indication of good stability for dispersion of these nanoparticles. Moreover, the negative surface charge of particles due to the electrostatic interaction of surface-modified particles in the aqueous medium may explain the agglomeration delay and enhanced particles' distribution in the solvent.

Since the non-ionic PEG chains may create a hydrated layer around nanoparticles in aqueous medium, a steric repulsion with other particles can happen and agglomeration can be prevented.¹⁵ Therefore, nanoparticles coated with PEG have smaller particle sizes. Without wishing to be bound by theory, dissolution—precipitation mechanism may be responsible for BaTiO₃ nanoparticles' formation involving the reaction between hydroxyl titanium complexes (Ti(OH))ⁿ⁻ and barium ions, and then precipitation of BaTiO₃ particles^{19,29}. Higher concentration of Ba²⁺ ions in BT-2 sample may increase nucleation rate and crystallization, and may prevent particle growth. Furthermore, PEG polymers adsorbed on the surface of BaTiO₃ particles may slow down nucleation, ending in smaller particle size formation in BT-3 sample.¹⁹ On the other hand, higher KOH concentration also accelerates nucleation rate, creating smaller particles with higher agglomeration tendency, resulting lower stability in the aqueous media.

### Conclusions

Water dispersed BaTiO₃-PEG core-shell particles with an average particle size of 60 nm and tetragonality value of 1.005 were prepared using a simple and fast low-temperature synthesis method. Desired BaTiO₃ phase was achieved with [Ba2+]/[Ti4+] ratio of 1:1 and KOH concentration of 1.5 M, at a reaction temperature of 100° C. The impact of experimental conditions on particle size and crystal structure were studied, confirming lattice expansion and tetragonality reduction in smaller particles. Surface bonding between BaTiO₃ particles and PEG molecules were studied using FT-IR and thermogravimetric analysis. Obtained zeta potential of −30 mV was an indication of good stability and redispersibility of surface-modified particles. The findings described herein may facilitate solving the problem of nanoparticles' aggregation, improving the stability of ferroelectric dispersion, and fabrication of optimum ferroelectric nanoparticles for application in the field of smart fluids and high-energy storage capacitors.

### Example 2

### Example 1 Supplementary Material

### Methods

Crystallite Size Determination

To determine crystallite size of particles, the (110) Bragg peak was fit as a Lorentzian peak, and crystallite size (DXRD) was calculated using the Scherrer equation:²¹

$${D}_{XRD} = \frac{K λ}{β cos θ}$$

where λ is the incident wavelength, K is the shape factor (=0.94 for spherical crystallites), β is the instrument-corrected line broadening of the sample at half the maximum intensity (FWHM), in radians, which is estimated through equation:

β=β_{observed}−β_{ref}. (S2)

Here, β_{observed} is the measured line broadening at half the maximum intensity for the NP sample (see FIG. 7), while β_{ref} is the measured line broadening at half the maximum intensity for microcrystalline BaTiO₃, taken to be representative of instrumental broadening.

### Data

See FIGS. 6 to 8, and Table S1.

TABLE I
Different reaction conditions including ratio of starting materials and
molarity of KOH solution used for BaTiO₃-PEG nanoparticle synthesis.
D_{XRD} is an average crystallite size calculated from Scherrer equation
obtained from the refined XRD data. D_{SEM} and D_{TEM} are average
particle sizes determined by SEM and TEM images, respectively.

| Sample | $\frac{Ba}{Ti}$ | $\frac{PEG}{KOH}$ | KOH (M) | D_{XRD} (nm) | D_{SEM} (nm) | D_{TEM} (nm) |
|---|---|---|---|---|---|---|
| BT-1 | 1 | $\frac{1}{2}$ | 1.5 | 39.8 | 69.9 ± 9.5 | 57.6 ± 10.3 |
| BT-2 | 2 | $\frac{1}{2}$ | 1.5 | 32.3 | 47.9 ± 7.7 | 40.4 ± 7.9 |
| BT-3 | 1 | 1 | 1.5 | 31.2 | 43.9 ± 6.3 | 40.2 ± 5.4 |
| BT-4 | 1 | $\frac{1}{2}$ | 1.6 | 33.6 | 39.8 ± 6.4 | 41.8 ± 6.3 |
| BT-5 | 1 | $\frac{1}{2}$ | 1.7 | 29.9 | 43.4 ± 7.2 | 37.4 ± 4.8 |

TABLE II
Lattice parameters (a, b, c) and internal atomic
lengths, obtained from the refined XRD data.

| | a = b | c | | d_{Ba—Ti} | d_{Ti—O1} | d_{Ti—O2} |
|---|---|---|---|---|---|---|
| Sample | (Å) | (Å) | c/a | (Å) | (Å) | (Å) |
| BT-1 | 4.03(1) | 4.05(2) | 1.005 | 3.49(8) | 2.02(6) | 2.01(6) |
| BT-2 | 4.05(7) | 4.07(5) | 1.004 | 3.51(9) | 2.03(8) | 2.02(9) |
| BT-3 | 4.04(9) | 4.06(4) | 1.004 | 3.51(1) | 2.03(2) | 2.02(5) |
| BT-4 | 4.04(5) | 4.06(4) | 1.004 | 3.50(8) | 2.03(2) | 2.02(3) |
| BT-5 | 4.04(6) | 4.06(5) | 1.004 | 3.50(9) | 2.03(3) | 2.02(2) |

TABLE S1
Multiplicity an atomic positions in BaTiO₃ structure
with tetragonal structure (space group of P4/mmm).

| Atom | Multiplicity | Coordinates |
|---|---|---|
| Ba | 1 | (0, 0, 0) |
| Ti | 1 | (0.5, 0.5, 0.5) |
| O1 | 1 | (0.5, 0.5, 0) |
| O2 | 2 | (0.5, 0, 0.5) |

### Example 3

### Surfactant Impact on the Colloidal Stability of BaTiO₃ Nanoparticles

Barium titanate, BaTiO₃, nanoparticles (NPs) have been used as a ferroelectric/piezoelectric/pyroelectric material in the electronic-optical ceramic industry. The stability and durability of BaTiO₃ NP suspension can be a matter of concern for advanced applications in wet-ceramic manufacturing, imaging, and electrorheological fluids. As described herein, the effect of three different surfactants were investigated—namely sodium dodecylbenzenesulfonate (anionic), cetyltrimethylammonium bromide (cationic), and sorbitan monooleate (non-ionic)—on the stability of PEGylated BaTiO₃ nanoparticles in two solvents (water and ethylene glycol), by means of dynamic light scattering, z-potential, UV-visible spectroscopy, scanning electron microscopy, and visual observation. Findings indicated that the anionic surfactant acted as a more favorable stabilizer for BaTiO₃ nanofluids, while the cationic surfactant was a less favourable stabilizer in both water and ethylene glycol, due to the balance between attraction and repulsive forces. The results indicated a simple and effective approach to controlling and improving the colloidal stability of BaTiO₃ nanoparticles.

Experimental Methods

A. Materials

High-purity barium(II) acetylacetonate hydrate (Ba(acac)2_xH2O) and titanium diisopropoxide bis(acetylacetonate) ((O-i-Pr)₂Ti(acac)2, 75 wt. % in isopropanol), poly(ethylene glycol) ((HO(CH2CH2O)nH), Mw=400), potassium hydroxide (KOH, 85%), ethylene glycol (98%), sodium dodecylbenzenesulfonate (SDBS) and polysorbate 80 (SPAN 80) were purchased from Sigma Aldrich. Cetyltrimethylammonium bromide (CTAB) was purchased from MP Biomedical LLC. Ethanol, glacial acetic acid (99.7%) and formic acid (98%) were used for NPs' washing procedure. Distilled water (DI) was used in all experiments. All chemicals and solvents were used as-received without any further purification.

B. Nanoparticle Synthesis

BaTiO₃@PEG (BP) NPs with an average particle size of 50-60 nm were synthesized by a low-temperature solution method using Ba(acac)₂ and (O-i-Pr)₂Ti(acac)₂ as precursors. The synthesis method and complete characterization have been reported in detail elsewhere.⁴⁵ In a representative protocol, 1 mmol of Ba(acac)_{2_}xH2O powder and 1 mmol of (O-i-Pr)₂Ti(acac)₂ solution were mixed in 3 mL of PEG400 in a round-bottom flask under nitrogen atmosphere and stirring for 30 min. Aqueous KOH (6 mL, 1.5 M) was then added to the mixture to adjust the pH of the solution to ca. 14; the solution was then heated to ca. 100±5° C., and allowed to reflux for 2 hrs. At this point, 6 mL of distilled water was added to the mixture, and maintained at 100±5° C. for an additional 2 hrs. White precipitates were obtained by washing and centrifugation (6000 rpm for 10 min) two times with ethanol, followed by formic acid (1 M). Carbonate impurities were removed by washing the product with diluted (0.5 w/w %) acetic acid. The final powders were dried at 60° C. in a vacuum oven overnight, yielding BaTiO₃@PEG nanoparticles, BP.

C. Nanofluid Preparation

BP NPs (20 mg) were mixed with 100 mL of solvent (distilled water (DI), or ethylene glycol (EG)) and sonicated for 30 min to make a 200 ppm BP dispersion. In a second vial, 20 mg of surfactant is dissolved in 100 mL solvent and then the desired amount of surfactant solution was added to the 5 mL BP dispersion to obtain the final surfactant concentrations of 0, 10, 20, 40, 80 and 100 ppm with 100 ppm NPs. The final mixture was dispersed with the help of ultrasonic agitation for 30 min to obtain the stable dispersed solution. In this work, two base fluids of DI and EG and three surfactants of SDBS, CTAB and SPAN80 were studied. Table S2 summarizes the NPs and surfactants' concentrations as well as type of surfactant and solvent in each nanofluid sample.

D. Nanoparticle Characterization

DLS and ζ potentials. Hydrodynamic diameter and ζ-potential were efficient techniques to assess the stability of nanofluids by measuring the size distribution of suspended NPs and their surface charge. ζ-potential was the potential difference between the dispersion medium and the stationary layer of fluid attached to the dispersed particles. Generally, particles with larger surface charge (ζ-potential larger than ±20 mV) generated the larger repulsive force to attain better physical colloidal stability, while colloids with smaller ζ-potential were willing to aggregate or flocculate, due to the attractive Van der Waals forces between them, resulting in a larger DLS size.^{75,76} Herein, the DLS size and ζ-potentials of all nanofluids were carried out over time using a Malvern Zetasizer Nano ZS DLS system to analyze their particle aggregation and surface charge in both DI and EG solvents. Time point measurement was repeated three times at room temperature in the case of fresh nanofluids (0 hrs) and the same solutions 24 hrs later, with no disturbing.

UV-visible spectroscopy. One analytical technique to examine stability of dispersion is UV-visible spectroscopy, which measures the changes in transmitted light due to the light scattered (turbidimetry) or absorbed (absorbance) by NPs in suspension. With this technique, the extinction at a given wavelength was related to the concentration of NPs suspended in the solution through the Beer-Lambert law.⁷⁷ The extinction of BP nanofluids was measured at room temperature using a Mettler Toledo UVvisible Excellence (UV7) spectrometer. The spectra were collected over a wavelength range of 190-900 nm in a 1-cm cuvette. For each time-point, three sequential measurements were made for fresh nanofluids and the same solutions 24 hrs later, with no disturbing.

SEM. Drops (2 mL) of fresh BP suspensions were cast on a silicon wafer affixed to a standard SEM sample stubs using double-sided carbon adhesive tape. BP-DI samples were dried in air over night while BP-EG samples were placed in a vacuum chamber for 15 min, as they were not dry completely in air. All SEM images were acquired with a FEI Quanta 250 FEG field-emission SEM at an energy of 10 keV. Micrographs were analysed using the ImageJ freeware.⁷⁸

III. Results

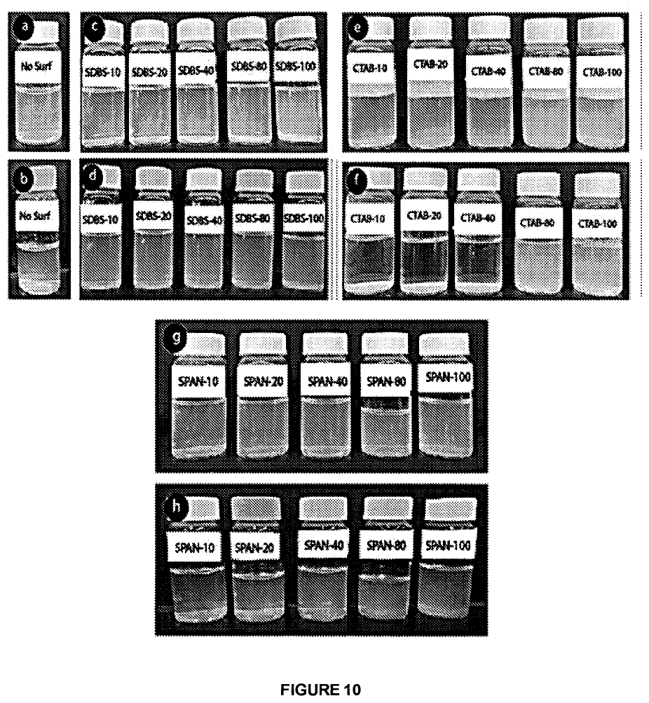

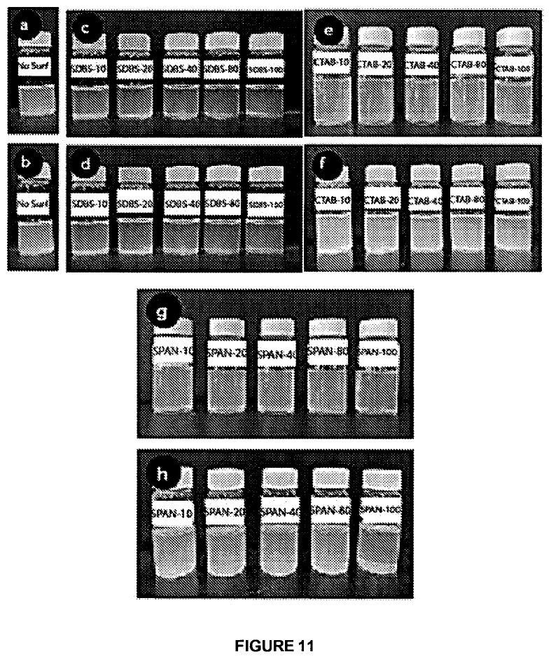

Visual Test. The visual observation of water-based nanofluids is presented in FIG. 10, which shows the solutions containing SDBS and SPAN80 in DI stayed whitish-milky color over time. Adding CTAB (10-40 ppm concentration) resulted in particle precipitation after 24 hrs (Fig. S10f), indicating the lower stability of these samples. Furthermore, CTAB appeared to make more foam in the solutions at 0 hrs, compared to other surfactants. Visual test of NP dispersions in EG (FIG. 11) indicated a better stability for all surfactants. There was no foam formation observed in the presence of CTAB. In general, the dark color of fresh solutions including CTAB compared to those with SDBS and then SPAN80 could be the sign of particles' aggregation.

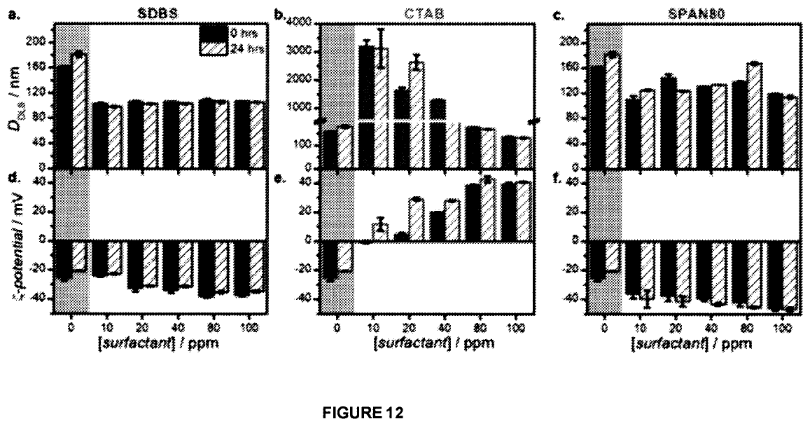

DLS and ζ-Potential. In order to obtain a better understanding of the NPs stability in the presence of surfactants, the hydrodynamic diameter size and ζ-potential of nanofluids were measured. FIGS. 12a-c shows the average hydrodynamic diameter of NPs in DI using different concentrations of SDBS, CTAB and SPAN 80, after solution preparation and 24 hrs later. The average hydrodynamic diameter in control colloidal solution with no surfactant was around 160 nm, which slightly agglomerated after 24 hrs (180±4.5 nm) (see FIG. 12ac, grey highlight). This result was interpreted as small aggregates of a few BaTiO₃ NPs.⁴⁵ Solutions including SDBS showed a size reduction to (˜105±3 nm) for all added surfactant amounts. The hydrodynamic diameter fluctuated between 110 to 160 nm for solutions containing SPAN80, with no apparent discernable trend. Adding smaller amounts of CTAB (10-40 ppm) resulted in larger agglomerates (˜600 to 3000 nm); upon addition of more CTAB, the hydrodynamic radius fell close to the control sample (130-170 nm).

The measured ζ-potential of BP NPs in DI water with no surfactant showed a slight variation over 24 hrs (˜−25±6 mV), see FIGS. 12d-f. Adding SDBS and SPAN80 increased the magnitude of ζ-potential, varying around an average value of −35 mV and −45 mV for colloidal mixture using SDBS and SPAN80, respectively. Interestingly, the ζ-potential of colloidal mixture using CTAB converted to a positive value due to the cationic nature of surfactant. The ζ-potential values of less than +20 mV for fresh samples with CTAB concentrations of 10, 20 and 40 ppm indicated a lower stability of the NPs, whereas more stable particles (ζ-potential ˜+30 mV and above) were obtained with higher concentrations (80 and 100 ppm).

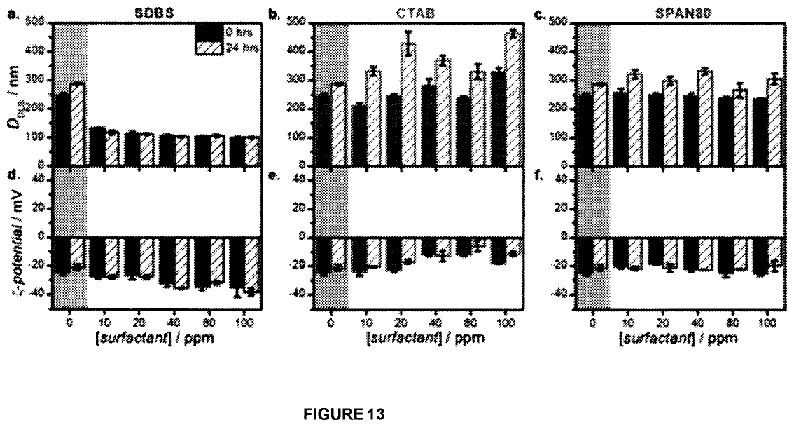

As seen in FIGS. 13a-c, the EG NP solutions without any surfactant showed slightly larger hydrodynamic diameters (˜250 nm) than in DI water. The hydrodynamic diameter decreased in the presence of SDBS, it increased upon addition of CTAB, and remained almost constant in the presence of SPAN80. Larger hydrodynamic diameter in solutions containing CTAB after 24 hrs indicated the particles' agglomeration and lower stability, while consistent and stable trends in the DLS-determined sizes for solutions containing SDBS and SPAN80 suggested higher stability.

FIGS. 13d-f depicted the ζ-potential of BP NPs in EG in different surfactant concentrations. The measured ζ-potentials of colloidal solutions with SDBS showed almost similar trend as BP-DI-SDBS samples, increasing from ˜−24 to −40 mV. Dispersions containing CTAB showed a decrease in the magnitude of ζ-potential (˜−10 mV), indicating a stability reduction while dispersion samples containing SPAN80 presented the minimum variation over time and concentration. Generally, the DLS size and z-potential trends for colloidal solutions in both DI and EG followed the trends observed in FIGS. 10 and 11.

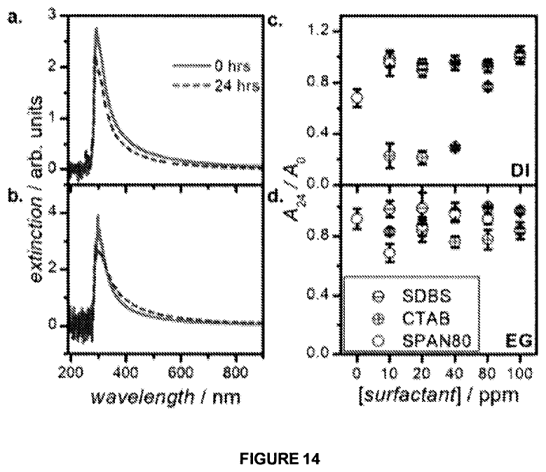

UV-visible spectroscopy. FIGS. 14a-b shows the UV-visible spectra of BP-DI-CTAB-80 and BP-EG-CTAB-80 nanofluids (c.f. Table S2) over 24 hrs. All other solutions showed similar spectra with a maximum peak at wavelength ˜285-294 nm, a characteristic feature of BaTiO₃ NPs. Generally, solutions with the minimum reduction in intensity had the maximum stability over time due to the minimum change in the dispersed NPs concentrations. To examine solutions' stability, the relative maximum intensity of each sample (at the maximum absorbance peak) at 24 hrs (A₂₄) compared to the initial (A₀) was plotted in FIG. 14cd. Among the results, BP-DI-SDBS, BP-DI-SPAN80 and BP-EG-SDBS dispersions showed no significant reduction in extinction after 24 hrs (A₂₄/A₀˜1), while the extinction of BP-EG-SPAN80 and BP-EG-CTAB slightly decreased. BP-DI-CTAB showed the least stability (up to 80 ppm concentration). Moreover, BP NPs were relatively more stable in EG than DI water in the absence of surfactant. Results were in good agreement with DLS and ζ-potential measurements presented above.

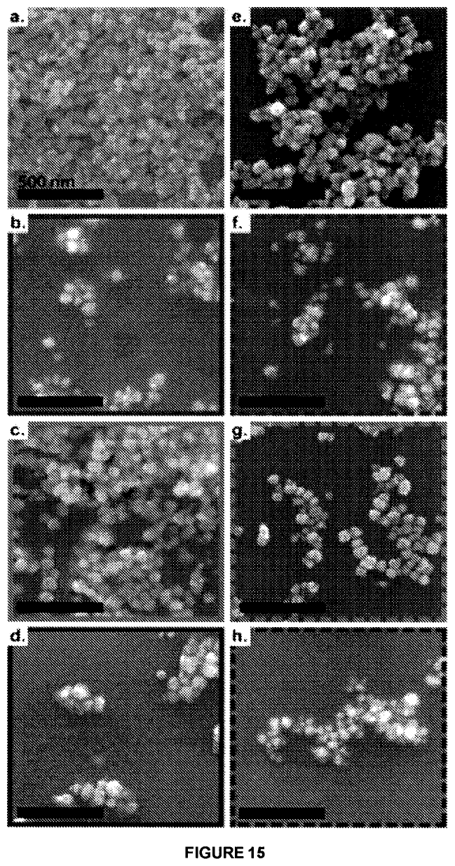

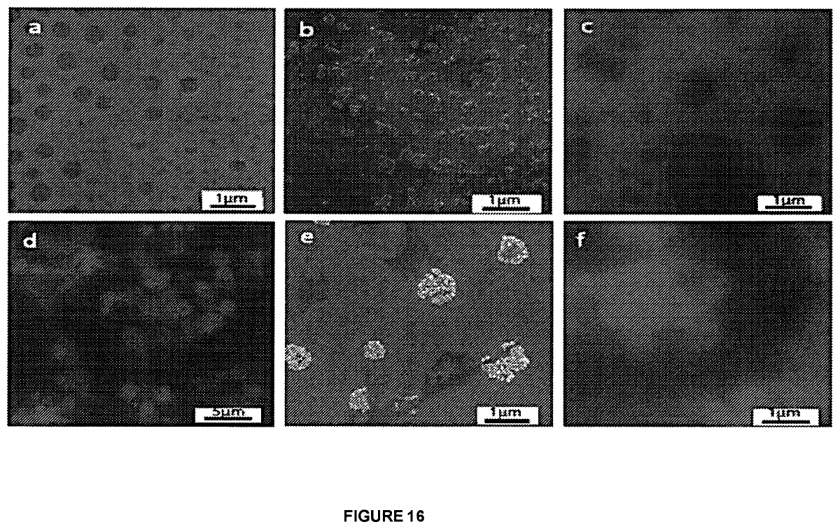

SEM. The morphology of BP nanofluids in 0 and 100 ppm surfactants was studied using SEM after sonicating the solutions for 30 min and drying the mixture in air (waterbased fluids) or vacuum (EG-based fluids). Micrographs (see FIG. 15) indicated the agglomeration of particles in the presence of CTAB (FIGS. 15c and g), compared to SDBS (FIGS. 15b and f) and SPAN80 (FIGS. 15d and h). Dispersibility of NPs in EG was generally improved relative to DI. Room temperature micrographs of a) DI-SDBS; b) DI-CTAB; c) DI-SPAN80; d) EG-SDBS; e) EG-CTAB; f) EG-SPAN80 are depicted in FIG. 16.

IV. Discussion

According to the Derjaguin, Landau, Verway and Overbeek (DLVO) theory, the stability of nano suspensions can be determined by the sum of Van der Waals attractive forces and electrostatic repulsive forces between NPs during the Brownian motion inside the fluid.⁷⁹ If the Van derWaals attraction force dominates over the electrostatic repulsive force, two particles can bond together and aggregate in clusters with increased size and then precipitate due to gravity, resulting an unstable suspension. Therefore, enhancement of repulsive forces over attractive forces can provide stability by preventing the particle aggregation.⁸⁰

The role of a surfactant was described herein was creating an effective NPs coating to induce steric or electrostatic repulsions that could counterbalance the Van der Waals attractions. Based on the DLS, ζ-potential, and UV-visible results, the anionic surfactant (SDBS) was a more effective stabilizer for the dispersion of BP NPs among all of the tested modifiers in both water and EG solvents. This was attributed to the electrostatic stabilization aided by SDBS because of an increase in the absolute value of the BP NP surface charge reflected in the value of ζ-potential in both water and EG (see FIGS. 12 and 13). The electrostatic stabilization was considered to have occurred by a supposed adsorption of SDBS on to the surface of NPs. It was considered that this adsorption created an electrical double layer that resulted in a Coulombic repulsion force between the NPs. In other words, the surface coverage increased with an increasing in surfactant concentration, which increased the potential of the inner Helmholtz layer, leading to an increase in the charge, mutual repulsion and hence, an increase in the physical stability of the suspensions in both water and EG. Although the electrostatic stabilization was of importance, the steric effect of the double layer structure around NPs also needed to be taken into account.⁸¹ These combined effects of SDBS resulted in the stabilization of BP NP dispersions that did not initiate the aggregation process over 24 hrs.

The results also indicated that adding SPAN80 as a non-ionic surfactant increased the nanofluid stability in both water and EG, but to a lower extent compared to SDBS. Although the slow aggregation process was observed in the DLS measurements for SPAN 80 compared to SDBS (see FIGS. 12c and 13c), no drastic increase in the size of the agglomerates was observed after 24 hrs. For particles dispersed in water, the enhancement of the aggregation stability of BP NPs modified by SPAN80 could be connected to a combination of both electrostatic and steric stabilization, as the ζ-potential of SPAN80 increased nearly two times compared to that of bare BP NPs. Therefore, both the electrostatic stabilization and the steric effect of the double layer structure was potentially a result of BP NPs stabilization in the presence of SPAN 80. However, the stability of nanofluids in EG and in the presence of SPAN 80 was mostly connected to steric stabilization. The electrostatic stabilization effect of SPAN 80 could not be taken into account in EG solution as the ζ-potential of BP NPs modified by SPAN 80 in EG remained nearly unchanged compared to bare BP NPs in EG (see FIG. 13f). This steric mechanism of the stabilization could be attributed to the formation of a compact layer at the NP surface due to the adsorption of non-ionic surfactant to BP NPs.

For the cationic surfactant (CTAB), the stability of BP NPs with a negatively charged surface occurred only after an optimum concentration in both water and EG. Based on DLS, ζ-potential and UV-visible measurements, at low CTAB concentrations in water (especially 10 ppm and 20 ppm), the electrostatic interactions with negatively charged BP NPs and positively charged surfactant resulted in charge neutralization and formation of larger aggregates (see FIG. 12b). However, the surface charge of the BP NPs changed their sign to positive values as the CTAB concentration increased in water, and ζ-potential increased drastically at concentrations above 80 ppm (see FIG. 12e). For EG, the NPs charge neutralization happened up to a CTAB concentration above the studied limit. Also, the absolute value of ζ-potential increased at 100 ppm after a reduction to a concentration of 80 ppm. Thus, different optimum concentrations existed for both water and EG, after which the stability of BP NPs increased with increasing CTAB concentration. As reported previously,⁸²⁻⁸⁶ at low concentrations of cationic surfactants, there is a monolayer adsorption of surfactants on to the surface of negatively charged NPs. However, there will be a bilayer (chain-chain interaction of surfactants) adsorption of surfactants on to the NP surface after an optimum concentration. This bilayer formation of cationic surfactants on the NPs at high surfactant concentration prevents NPs agglomeration due to repulsive electrostatic forces between the positively charged colloidal particles, stabilizing the dispersion in turn.⁸⁷⁻⁸⁸ Thus, the positively charged surfactant molecules stabilize negatively charged NPs by forming a bilayer (chain-chain interaction of surfactants) assembly surrounding the NPs.^{82,83,90} Herein, although the electrostatic stabilization of BP NPs with CTAB occurred at concentrations above 80 ppm, a higher surfactant concentration was needed compared to SDBS and SPAN 80, which made this surfactant a less preferable candidate for BP NP stabilization.

V. Conclusions

In summary, herein was described a study on the effect of three surfactants of SDBS, CTAB and SPAN 80 on the stability of BaTiO₃-PEG NPs in water and EG media. The nanofluids were prepared at six different surfactants concentrations of 0, 10, 20, 40, 80, 100 ppm in both water and EG with 100 ppm NPs concentrations. The surfactant stabilizing effect was monitored via Dynamic Light Scattering, ζ-potential, and UV-visible spectra measurements, which were further supported by visual test and SEM analysis. Among the three different surfactant modifiers, the anionic surfactant (SDBS) exhibited a relatively higher stabilization of BaTiO₃ NPs against aggregation in both water and EG at concentrations as low as 10 ppm as a result of electrostatic stabilization. Following SDBS, the non-ionic surfactant (SPAN 80) revealed stabilization effects at concentrations above 10 to 20 ppm. The mode of stabilization for the non-ionic surfactant was considered to be mainly due to steric stabilization in EG, and a combination of steric and electrostatic stabilizations in water. For CTAB, there existed an apparently optimum concentration over which the electrostatic repulsion forces could overcome the Van der Waals attraction forces. This was considered to be due to the electrostatic interaction between oppositely charged NPs and surfactant. These apparent optimum CTAB concentrations occurred at concentrations above 80 ppm, which made this surfactant a less desired candidate for BaTiO₃ NP stabilization.

TABLE S2
Experimental conditions of nanofluids' synthesis including BaTiO₃-PEG nanoparticles'
concentration (BP), surfactants' type and concentration, and solvent type.

| | NPs Concentration | | [Surfactant] | |
|---|---|---|---|---|
| Sample | (ppm) | Surfactant | (ppm) | Solvent |
| BP-DI | 100 | N/A | 0 | Water |
| BP-DI-SDBS-10 | 100 | SDBS | 10 | Water |
| BP-DI-SDBS-20 | 100 | SDBS | 20 | Water |
| BP-DI-SDBS-40 | 100 | SDBS | 40 | Water |
| BP-DI-SDBS-80 | 100 | SDBS | 80 | Water |
| BP-DI-SDBS-100 | 100 | SDBS | 100 | Water |
| BP-DI-CTAB-10 | 100 | CTAB | 10 | Water |
| BP-DI-CTAB-20 | 100 | CTAB | 20 | Water |
| BP-DI-CTAB-40 | 100 | CTAB | 40 | Water |
| BP-DI-CTAB-80 | 100 | CTAB | 80 | Water |
| BP-DI-CTAB-100 | 100 | CTAB | 100 | Water |
| BP-DI-SPAN-10 | 100 | SPAN80 | 10 | Water |
| BP-DI-SPAN-20 | 100 | SPAN80 | 20 | Water |
| BP-DI-SPAN-40 | 100 | SPAN80 | 40 | Water |
| BP-DI-SPAN-80 | 100 | SPAN80 | 80 | Water |
| BP-DI-SPAN-100 | 100 | SPAN80 | 100 | Water |
| BP-EG | 100 | N/A | 0 | Ethylene glycol |
| BP-EG-SDBS-10 | 100 | SDBS | 10 | Ethylene glycol |
| BP-EG-SDBS-20 | 100 | SDBS | 20 | Ethylene glycol |
| BP-EG-SDBS-40 | 100 | SDBS | 40 | Ethylene glycol |
| BP-EG-SDBS-80 | 100 | SDBS | 80 | Ethylene glycol |
| BP-EG-SDBS-100 | 100 | SDBS | 100 | Ethylene glycol |
| BP-EG-CTAB-10 | 100 | CTAB | 10 | Ethylene glycol |
| BP-EG-CTAB-20 | 100 | CTAB | 20 | Ethylene glycol |
| BP-EG-CTAB-40 | 100 | CTAB | 40 | Ethylene glycol |
| BP-EG-CTAB-80 | 100 | CTAB | 80 | Ethylene glycol |
| BP-EG-CTAB-100 | 100 | CTAB | 100 | Ethylene glycol |
| BP-EG-SPAN-10 | 100 | SPAN80 | 10 | Ethylene glycol |
| BP-EG-SPAN-20 | 100 | SPAN80 | 20 | Ethylene glycol |
| BP-EG-SPAN-40 | 100 | SPAN80 | 40 | Ethylene glycol |
| BP-EG-SPAN-80 | 100 | SPAN80 | 80 | Ethylene glycol |
| BP-EG-SPAN-100 | 100 | SPAN80 | 100 | Ethylene glycol |

### REFERENCES

1. M. Acosta, N. Novak, V. Rojas, S. Patel, R. Vaish, J. Koruza, G. A. Rossetti, and J. Rodel, Appl. Phys. Rev 4, 041305 (2017).
2. K. Uchino, E. Sadanaga, and T. Hirose, J. Am. Ceram. Soc. 72, 1555 (1989).
3. Z. Zhao, V. Buscaglia, M. Viviani, M. T. Buscaglia, L. Mitoseriu, A. Testino, M. Nygren, M. Johnsson, and P. Nanni, Phys. Rev. B 70, 024107 (2004).
4. C. Xiao, Z. Chi, W. Zhang, F. Li, S. Feng, C. Q. Jin, X. Wang, X. Deng, and L. Li, J. Phys. Chem. Solids 68, 311-314 (2007).
5. Z. G. Shen, J. F. Chen, H. k. Zou, and J. Yun, J. Colloid Interface Sci. 275, 158-164 (2004).
6. J. Li, K. Inukai, A. Tsuruta, Y. Takahashi, and W. Shin, J. Asian. Cerm. Soc. 5, 444-451 (2017).
7. C. Hai, K. Inukai, Y. Takahashi, N. Izu, T. Akamatsu, T. Itoh, and W. Shin, Mater. Res. Bull. 57, 103-109 (2014).
8. G. Ciofani, S. S. Danti, Moscato, L. Albertazzi, D. D'Alessandro, D. Dinucci, F. Chiellini, and A. Petrini, M. and Menciassi, Colloids Surf. B: Biointerfaces 76, 535-543 (2010).
9. X. Wang, T. Karaki, K. Koyanagi, and T. Fujii, Jpn. J. Appl. Phys 59 (2020).
10. L. S. Simon-Seveyrat, A. Hajjaji, Y. Emziane, B. Guiffard, and D. Guyomar, Ceram. Int. 33, 1, 35 (2007).
11. G. Panomsuwan and H. Manuspiya, J. Appl. Phys. A 124, 10, 1 (2018).
12. S. K. Lee, T. J. Park, G. J. Choi, K. K. Koo, and S. W. Kim, Mater. Chem. Phys. 82, 3, 742 (2003).
13. S. G. Kwon, B. H. Park, K. Choi, E. S. Choi, S. Nam, J. W. Kim, and K. J. H., Journal of the Eur. Ceram. Soc. 26, 1401-1404 (2006).
14. S. S. Tripathy and A. M. Raichur, J. Exp. Nanosci. 6, 2, 127-137 (2011).
15. J. S. Suk, Q. Xu, N. Kim, J. Hanes, and L. M. Ensign, Adv. Drug. Deliv. Rev. 99, 28-51 (2016).
16. S. Moharana, M. K. Mishra, B. Behera, and R. N. Mahalinga, Polym. Sci. 59, 405-415 (2017).
17. J. G. Kim, W. P. Tai, K. J. Lee, and W. S. Cho, Ceram. Int. 30, 2223-2227 (2004).
18. J. Zhu, W. Li, X. Huo, and Y. Zhu, J. Phys. D: Appl. Phys. 48, 355301 (2015).
19. J. Li, K. Inukai, Y. Takahashi, and W. Shin, J. Asian. Cerm. Soc. 4, 394-402 (2016).
20. T. Roisnel and J. Rodriguez-Carvajal, Proceedings of the Seventh European Powder Diffraction Conference, Ed. R. Delhez and E. J. Mittenmeijer, 118-123 (2000).
21. D. M. Smilgies, J. Appl. Cryst. 42, 1030-1034 (2009).
22. C. A. Schneider, W. S. Rasband, and K. W. Eliceiri, Nat. methods 9, 7, 671 (2012).
23. Y. Gao, V. V. Shvartsman, A. Elsukova, and D. C. Lupascu, J. Mater. Chem. 22, 17573-17583 (2012).
24. S. Yoon, S. Baikw, M. G. Kim, N. Shin, and I. Kim, Am. Ceram, Soc., 90(1), 311-314 (2007)
25. O. G. Grendal, A. B. Blichfeld, S. L. Skjaervo, W. V. Beek, S. M. Selbach, T. Grande and M. A. Einarsrud, Crystals, 8(6), 253 (2018)
26. M. B. Smith, K. Page, T. Siegrist, P. L. Redmond, E. C. Walter, R. Seshadri, L. E. Brus, and S. M. L., J. Am. Chem. Soc. 130, 6955 (2008).
27. P. M. Diehm, P. Agoston, and K. Albe, Chem. Phys. Chem 13, 2443 (2012)
28. S. Tsunekawa, K. Ishikawa, Z. Q. Li, Y. Kawazoe, and A. Kasuya, Phys. Rev. Lett. 85, 3440 (2000)
29. H. Xu, and L. Gao, Materials Letters 57, 490-494 (2000)
30. H. Zarkoob, S. Ziaei-Rad, M. Fathi, and H. Dadkhah, Adv. Eng. Mater 14, 322-329 (2012).
31. M. Schult, E. Buckow, and H. Seitz, Curr. Dir. Biomed. Eng 2(1), 95-99 (2016).
32. G. Ciofani, S. Danti, D. D'Alessandro, S. Moscato, M. Petrini, and A. Menciassi, Nanoscale. Res. Lett. 5, 1093-1101 (2010).
33. Y. N. Yoon, D. S. Lee, H. J. Park, and J. S. Kim, Sci. Rep. 10, 2560, 1 (2020).
34. R. H. Huang, N. B. Sobol, A. Younes, T. Mamun, J. S. Lewis, R. V. Ulijn, and S. O'Brien, ACS Appl. Mater. Interfaces 12, 51135-51147 (2020).
35. U. Paik, V. Hackley, S. Choi, and Y. Jung, Colloids Surf. A 135, 77-88 (1998).
36. D. Khastgir and K. Adachi, Polymer 41, 16, 6403-6413 (2000).
37. Z. Zheng, S. Gong, S. Cheng, D. Zhou, Y. Hu, and H. Liu, Key Eng. Mater. 368, 469 (2008).
38. G. Kume, M. Gallotti, and G. Nunes, J. Surfact. Deterg. 11, 1-11 (2008).
39. S. S. Tripathy and A. M. Raichur, J. Exp. Nanosci. 6, 127-137 (2011).
40. J. Jean and H. Wang, J. Mater. Res. 13, 2245 (1998).
41. Z. G. Shen, J. Chen, H. Zou, and Y. J., J. Colloid Interface Sci. 275, 158 (2004).
42. J. Jean and H. Wang, J. Am. Ceram. Soc. 81, 1589 (1998).
43. Y. Hu, S. Gong, and D. Zhou, Mater. Sci. Eng. B, 99, 520 (2003).
44. X. Wang, B. Lee, and L. Mann, Colloids Surf. A. 202, 71 (2002).
45. M. Taheri, B. Zanca, M. Dolgos, S. Bryant, and S. Trudel, Mater. Adv. 2, 5089-5095 (2021).
46. A. O. Gbadamosi, R. Junin, M. Manan, A. Agi, and A. S. Yusuff, Int. Nano Lett. 9, 171 (2019).
47. M. Rosen, John Wiley & Sons, New York, 2ed (1989).
48. Y. Chevalier and T. Zemb, Rep. Prog. Phys. 53, 279-371 (1990).
49. C. Tanford, Wiley, New York (1980).
50. R. J. Hunter, Foundations Colloid Sci. xx, 635 (2001).
51. C. Luo, Y. Zhang, X. Zeng, Y. Zeng, and Y. Wang, J. Colloid Interface Sci. 288, 444 (2008).
52. D. F. Evans and H. Wennerström, The colloidal domain: where physics, chemistry, biology, and technology meet (Wiley-VCH, 1999).
53. M. Popa, T. Pradell, D. Crespo, and J. M. Calderón-Moreno, Colloids Surf. A Physicochem. Eng. Asp. 303, 184 (2007).
54. K. S. Chou and C. Y. Ren, Mater. chem. phys. 64, 241 (2000).
55. H. H. Huang, X. P. Ni, G. L. Loy, K. L. Chew, C. H. and Tan, F. C. Loh, and G. Q. Xu, Langmuir 12, 909 (1996).
56. Z. Zhang, B. Zhao, and L. Hu, J. Solid State Chem. 121, 105 (1996).
57. M. Chen, L. Y. Wang, J. T. Han, J. Y. Zhang, Z. Y. Li, and D. J. Qian, J. Phy. Chem. B 110, 11224 (2006).
58. C. W. Chou, S. H. Hsu, H. Chang, S. M. Tseng, and H. R. Lin, Polym. Degrad. Stab. 91, 1017 (2006).
59. L. M. Liz-Marzán and I. Lado-Touriño, Langmuir 12, 3585 (1996).
60. M. H. Lee, S. G. Oh, K. D. Suh, D. G. Kim, and D. Sohn, Colloids Surf. A Physicochem. Eng. Asp. 210, 49 (2002).
61. F. Mafuné, J. Y. Kohno, Y. Takeda, T. Kondow, and H. Sawabe, J. Phys. Chem. B. 104, 8333 (2000).
62. D. Yu and V. W. W. Yam, J. Phys. Chem. B. 109, 5497 (2005).
63. X. Zheng, L. Zhu, A. Yan, X. Wang, and Y. Xie, J. colloid interface sci. 268, 357 (2003).
64. Y. Hwang, J. K. Lee, J. K. Lee, Y. M. Jeong, S. I. Cheong, Y. C. Ahn, and S. H. Kim, Powder Technol. 186, 145 (2008).
65. L. Kvitek, A. Paná\check{}cek, J. Soukupová, M. Kolá\check{}r, R. Ve\check{}ce\check{}rová, R. Prucek, M. Holecová, and R. Zbo\check{}ril, J. Phys. Chem. C 112, 5825 (2008).
66. S. Yi, T. Babadagli, and H. Li, Pet. Sci. 17, 1014 (2020).
67. M. Faraji, R. Poursalehi, and M. Aliofkhazraei, Procedia Mater. Sci. 11, 684 (2015).
68. L. Jiang, L. Gao, and J. Sun, J. colloid interface sci. 260, 89 (2003).
69. X. J. Wang, H. Li, X. F. Li, Z. F. Wang, and F. Lin, Chin. Phys. Lett. 28, 86601 (2011).
70. A. Ghadimi and I. H. Metselaar, Exp. Therm. Fluid Sci. 51, 1 (2013).
71. S. Skoglund, E. Blomberg, I. O. Wallinder, I. Grillo, J. S. Pedersen, and L. M. Bergström, Phys. Chem. Chem. Phys. 19, 28037 (2017).
72. S. Gomez-Grana, F. Hubert, F. Testard, A. Guerrero-Martinez, I. Grillo, L. M. Liz-Marzán, and O. Spalla, Langmuir 28, 1453 (2012).
73. W. Mutuku, Asia Pac. J. Comput. Engin. 3, 1, 1-15 (2016).
74. G. Sekrani and S. Poncet, Appl. Sci. 8, 2311, 1 (2018).
75. J. Stetefeld, S. McKenna, and T. Patel, Biophys. Rev. 8, 409-427 (2016).
76. S. Bhattacharjee, J. Control. Release. 235, 337-351 (2016).
77. T. R. Ray, B. Lettiere, J. Rutte, and S. Pennathur, Langmuir. 31, 12, 3577-3586 (2015).
78. C. A. Schneider, W. S. Rasband, and K. W. Eliceiri, Nat. Methods 9, 671 (2012).
79. W. Yu and H. Xie, J. Nanomater. 711, 128 (2012).
80. B. M. Paramashivaiah and C. R. Rajashekhar, IOP Conf. Ser.: Mater. Sci. Eng. 149, 012083 (2016).
81. Y. H. Chen and C. S. Yeh, Colloids Surf. A: Physicochem. Eng. Asp. 197, 133 (2002).
82. B. P. Binks, J. A. Rodrigues, and W. J. Frith, Langmuir 23, 3626 (2007).
83. Q. Lan, F. Yang, S. Zhang, S. Liu, J. Xu, and D. Sun, Colloids Surf. A: Physicochem. Eng. Asp. 302, 126 (2007).
84. B. P. Binks and J. A. Rodrigues, Colloids Surf. A: Physicochem. Eng. Asp. 345 (1-3), 195 (2009).
85. Y. Zhu, J. Jiang, K. Liu, Z. Cui, and B. P. Binks, Langmuir 31 (11), 3301 (2015).
86. Z.-G. Cui, L.-L. Yang, Y.-Z. Cui, and B. Binks, Langmuir 26 (7), 4717(2010).
87. S. Skoglund, T. A. Lowe, J. Hedberg, E. Blomberg, I. O. Wallinder, S. Wold, and M. Lundin, Langmuir 29, 8882 (2013).
88. J. Hedberg, M. Lundin, T. Lowe, E. Blomberg, S. Wold, and I. Odnevall Wallinder, J. Colloid Interface Sci. 369, 193-201 (2012).
89. Z. Sui, X. Chen, L. Wang, Y. Chai, C. Yang, and J. Zhao, Chem. lett. 34, 100 (2005).
90. S. Majumder, B. Naskar, S. Ghosh, C. H. Lee, C. H. Chang, S. P. Moulik, and A. K. Panda, Colloids Surf. A: Physicochem. Eng. Asp. 443, 156 (2014).

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A method of forming dispersible ferroelectric nanoparticles, the method comprising
adding a barium precursor and a titanium precursor to a polyether to form a mixture;
basifying the mixture;
heating the mixture; and
forming dispersible ferroelectric nanoparticles, the dispersible ferroelectric nanoparticles comprising polyether-ylated barium titanate nanoparticles.

2. The method of claim 1, wherein the barium precursor comprises a barium acetylacetonate (acac) complex; and/or the titanium precursor comprises a titanium acetylacetonate (acac) complex.

3. The method of claim 2, wherein the barium acetylacetonate (acac) complex is Ba(acac)₂.xH₂O; and/or the titanium acetylacetonate (acac) complex is (O-i-Pr)₂Ti(acac)₂.

4. The method of claim 1, wherein the polyether is a low-molecular weight polyethylene glycol (PEG).

5. The method of claim 4, wherein the low-molecular weight PEG is PEG₇₀₀, or PEG₆₀₀, or PEG₅₀₀, or PEG₄₀₀, or PEG₃₀₀, or PEG₂₀₀.

6. The method of claim 5, wherein the low-molecular weight PEG is or PEG₄₀₀.

7. The method of claim 1, wherein basifying the mixture comprises:
adding a base and adjusting the pH of the mixture to >9, >13, or about 14; or
adding a base and adjusting the pH of the mixture to about 9 to about 13, or to about 13 to about 14.

8. The method of claim 7, wherein the base is an alkali metal hydroxide.

9. The method of claim 7, wherein the base is potassium hydroxide.

10. The method of claim 1, wherein heating the mixture comprises: refluxing the mixture; or refluxing the mixture at about 100° C. for between about 2 hours to about 4 hours.

11. The method of claim 1, wherein forming dispersible ferroelectric nanoparticles comprises forming polyether-ylated barium titanate nanoparticles:
by controlling particle size and dispersibility;
having an average size between about 35 nm to about 70 nm; or between about 40 nm to about 65 nm;
having a zeta potential between about −32 mV to about −22 mV; or between about −31 mV to about −28 mV; or about −30 mV; or
having a hydrodynamic radius size between about 150 nm to about 250 nm.

12. The method of claim 1, wherein forming dispersible ferroelectric nanoparticles comprises forming tetragonal polyether-ylated barium titanate nanoparticles.

13. A method of detecting oil or a hydrocarbon, the method comprising
introducing a ferroelectric tracer material into the oil or hydrocarbon, the ferroelectric tracer material comprising the dispersible ferroelectric nanoparticles formed by the method of claim 1; and
detecting the oil or hydrocarbon.

14. The method of claim 13, wherein detecting the oil or hydrocarbon comprises:
detecting a presence and/or measuring a distribution of an oil or a hydrocarbon in a subsurface formation via detecting the ferroelectric tracer material; or
detecting a presence and/or monitoring flow within hydrocarbon well or hydrocarbon reservoir via detecting the ferroelectric tracer material.

15. A composition comprising:
an oil or hydrocarbon recovery fluid, and
the dispersible ferroelectric nanoparticles formed by the method of claim 1,
the ferroelectric nanoparticles being dispersed in the recovery fluid;
the composition being operable for detecting a presence, measuring a distribution, or both of an oil or a hydrocarbon in a subsurface formation.

16. A composition comprising:
a fracking fluid and
the dispersible ferroelectric nanoparticles formed by the method of claim 1,
the ferroelectric nanoparticles being dispersed in the fracking fluid;
the composition being operable for detecting a presence and/or monitoring flowback of a flowback fluid comprising the fracking fluid and the ferroelectric nanoparticles dispersed in the fracking fluid from a hydrocarbon well or hydrocarbon reservoir.

17. A method for detecting an oil or hydrocarbon in a subsurface formation, the method comprising:
incorporating the dispersible ferroelectric nanoparticles formed by the method of claim 1 into an oil or hydrocarbon recovery fluid to form a mixture;
injecting the mixture into the subsurface formation;
measuring a dielectric constant of the ferroelectric nanoparticles; and
detecting a presence, measuring a distribution, or both of the oil or hydrocarbon in the subsurface formation.

18. A method for detecting a productive portion of a hydrocarbon reservoir or hydrocarbon well with flowback fluid, the method comprising:
incorporating the dispersible ferroelectric nanoparticles formed by the method of claim 1 into a fracking fluid to form a mixture;
injecting the mixture into the subsurface formation;
measuring a dielectric constant of the ferroelectric nanoparticles; and
detecting a presence and/or monitoring flowback of a flowback fluid, the flowback fluid comprising at least a portion of the mixture.

19. The composition of claim 15, wherein measuring a distribution comprises measuring an oil or hydrocarbon saturation distribution.

20. The method of claim 17, wherein measuring a distribution comprises measuring an oil or hydrocarbon saturation distribution.
